(19) United States
(12) Patent Application Publication
(10) Pub. No.: US 2026/0049505 A1
(43) Pub. Date: Feb. 19, 2026

(54) DOOR LATCH DEVICE

(71) Applicant: Mitsui Kinzoku Act Corporation, Yokohama-shi (JP)

(72) Inventor: Makoto KONDO, Kanagawa (JP)

(73) Assignee: Mitsui Kinzoku Act Corporation, Yokohama-shi (JP)

(21) Appl. No.: 19/301,887

(22) Filed: Aug. 15, 2025

(30) Foreign Application Priority Data
Aug. 19, 2024 (JP) 2024-137751

(51) Int. Cl. E05B 81/90; E05B 81/06; E05B 81/14

(52) U.S. Cl. CPC E05B 81/90; E05B 81/06; E05B 81/14

(57) ABSTRACT

A door latch device has a latch mechanism maintaining a door in a closed state, an electric release mechanism canceling a latched state by driving a motor, and a manual release mechanism canceling the latched state by a manual operation. The electric release mechanism includes an electric release lever operated by driving the motor. The electric release lever includes a first lever operated by driving the motor, and a second lever engaged with the latch mechanism. The manual release mechanism includes an inner lever operated by manually operating a vehicle interior operation portion. The door latch device further has a cancellation mechanism canceling a coupled state between the first lever and the second lever by an operation force of the vehicle interior operation portion, and a vehicle interior operation disabling mechanism selectively switching between a set state and an unset state.

### CROSS-REFERENCE TO RELATED APPLICATIONS

This application is based on and claims priority under 35 USC 119 from Japanese Patent Application No. 2024-137751 filed on Aug. 19, 2024, the entire content of which is incorporated herein by reference.

### TECHNICAL FIELD

The present disclosure relates to a door latch device attached to a door of a vehicle.

### BACKGROUND ART

This section provides background information related to door latch devices and is not necessarily prior art to the door latch device of the present disclosure.

In a door latch device attached to a door of a vehicle, an electrical door latch device (also called an E latch) capable of releasing engagement between a latch mechanism and a striker by a driving force of a motor is known. In addition to an electrical disengagement mechanism, the electric door latch device is provided with a mechanical disengagement mechanism capable of releasing the engagement between the latch mechanism and the striker by a manual operation of a handle or the like, as a countermeasure in case the motor becomes unable to be driven due to power interruption or the like.

Regarding this mechanical disengagement mechanism, for example, JP4617588B describes a door latch device capable of maintaining a set state a set state where engagement between a latch and a striker is not released even if an inside handle inside a vehicle is manually operated, in terms of safety and antitheft performance. JP7035709B describes a door lock device including a mechanism that restricts release of engagement even if not only a door inner handle inside a vehicle but also a door outer handle outside the vehicle is manually operated by setting an active lever to a lock position.

In the electrical door latch device, if the motor becomes unable to be driven after the electrical disengagement mechanism operates the latch mechanism from a latched state to an unlatched state, the latch mechanism may be maintained in a state where the latch mechanism cannot be locked to the striker (also referred to as a latch disabled state), and the door may not be able to close.

The door lock device described in JP7035709B is provided with a cancellation mechanism as a countermeasure against a case of the latch disabled state. When the door inner handle is operated, the active lever rotates to release connection between a release lever and a cancellation lever coupled by a cancel pin, and the door can be changed from an open state to a closed state.

### SUMMARY OF INVENTION

The present disclosure provides a door latch device that enables to cancel a latch disabled state with good operability even if the latch disabled state occurs, while ensuring safety and antitheft performance.

An aspect of the present disclosure relates to a door latch device to be attached to a door of a vehicle, the door latch device having:
a latch mechanism including a latch configured to be engaged with a striker provided on a vehicle body, and maintaining the door in a closed state with respect to the vehicle body by bringing the latch into a latched state where the latch is locked to the striker;
an electric release mechanism configured to cancel the latched state by driving a motor; and
a manual release mechanism configured to cancel the latched state by a manual operation, in which
the electric release mechanism includes an electric release lever operated by driving the motor,
the electric release lever includes:
   a first lever operated by driving the motor; and
   a second lever engaged with the latch mechanism in a coupled state of operating in conjunction with the first lever, to cancel the latched state,
the manual release mechanism includes an inner lever operated by manually operating a vehicle interior operation portion provided inside a vehicle cabin, and
the door latch device further has:
   a cancellation mechanism provided independently of the motor, and canceling the coupled state between the first lever and the second lever by an operation force of the vehicle interior operation portion transmitted via the inner lever, to allow the second lever to retract from a predetermined position; and
   a vehicle interior operation disabling mechanism selectively switching between a set state where an operation force of the vehicle interior operation portion is unable to be transmitted from the manual release mechanism to the latch mechanism, and an unset state where the operation force of the vehicle interior operation portion is able to be transmitted from the manual release mechanism to the latch mechanism.

According to the present disclosure, since the door latch device includes the cancellation mechanism that operates by the manual operation of the vehicle interior operation portion, even in a case where the motor becomes unable to be driven due to power shortage, failure, or the like and the latch disabled state is maintained, it is possible to cancel the latch disabled state by manually operating the vehicle interior operation portion. Therefore, since the door can be reliably closed even in an emergency, the antitheft performance is improved, and the reliability of the door latch device is improved. Since the cancellation mechanism is provided independently of the motor, the cancellation mechanism can operate without being affected by the stuck motor, and the latch disabled state can be canceled with good operability.

According to the present disclosure, since the vehicle interior operation disabling mechanism is provided that selectively switches between the set state where the operation force of the vehicle interior operation portion cannot be transmitted to the latch mechanism and the unset state where the operation force can be transmitted, it is possible to further improve the antitheft performance and safety.

### BRIEF DESCRIPTION OF DRAWINGS

Exemplary embodiment(s) of the present invention will be described in detail based on the following figures, wherein:

FIG. 1 is a right side view of a vehicle V to which a door latch device 1 according to each embodiment of the present disclosure is attached;

FIG. 2 is a perspective view of the door latch device 1 viewed from the rear and a vehicle inner side;

FIG. 3 is a perspective view of the door latch device 1 before a latch mechanism 20 is attached to a housing 11;

FIG. 4 is a perspective view of an electrical component 80 mounted on the door latch device 1;

FIG. 5 is a rear view of the latch mechanism 20;

FIG. 6 is a perspective view of the latch mechanism 20 (body 21 not illustrated) as viewed from a front side;

FIG. 7 is a rear view of a pawl lever 34 and an outer lever 71;

FIG. 8 is a view of an electric release mechanism 40, a manual release mechanism 60, and a cancellation mechanism 100 as viewed from the vehicle inner side;

FIG. 9 is an exploded perspective view of elements of the electric release mechanism 40, the manual release mechanism 60, and the cancellation mechanism 100;

FIG. 10 is a diagram illustrating the electric release mechanism 40 (left side) and the latch mechanism 20 (right side) in a standby position;

FIG. 11 is a diagram illustrating the electric release mechanism 40 (left side) and the latch mechanism 20 (right side) operated in a release direction;

FIG. 12 is a diagram illustrating the electric release mechanism 40 ((left side) and the latch mechanism 20 (right side) operated in a standby direction;

FIG. 13 is a diagram illustrating the manual release mechanism 60 (left side) and the latch mechanism 20 (right side) operated in the release direction;

FIG. 14 is a diagram illustrating the manual release mechanism 60 (left side) and the latch mechanism 20 (right side) operated in the standby direction;

FIG. 15 is a diagram (part 1) illustrating an operation of the cancellation mechanism 100 (left side) and the latch mechanism 20 (right side) when canceling a latch disabled state;

FIG. 16 is a diagram (part 2) illustrating the operation of the cancellation mechanism 100 (left side) and the latch mechanism 20 (right side) when canceling the latch disabled state;

FIG. 17 is a diagram (part 3) illustrating the operation of the cancellation mechanism 100 (left side) and the latch mechanism 20 (right side) when canceling the latch disabled state;

FIG. 18 is a view of a vehicle interior operation disabling mechanism 200 according to the second embodiment accommodated in a space S1 of the housing 11 as viewed from the vehicle inner side;

FIG. 19 is an enlarged view of the vehicle interior operation disabling mechanism 200 and the manual release mechanism 60;

FIG. 20 is a diagram illustrating an inner lever 61 in an unset state (left side) and the inner lever 61 in a set state (right side);

FIG. 21 is a perspective view of a pawl lever 34 according to a second embodiment;

FIG. 22 is a diagram illustrating a manner in which the door latch device 1 is shifted from the unset state (upper diagram) to the set state (lower diagram) by driving of a motor 201;

FIG. 23 is a diagram illustrating the vehicle interior operation disabling mechanism 200 (left side), the pawl lever 34, and the outer lever 71 (right side) when the door latch device 1 is in the set state;

FIG. 24 is a diagram illustrating the vehicle interior operation disabling mechanism 200 (left side), the pawl lever 34, and the outer lever 71 (right side) of the door latch device 1 shifted to the unset state by manually operating a key cylinder 5;

FIG. 25 is a diagram illustrating a configuration of a vehicle interior operation disabling mechanism 200 according to a third embodiment;

FIG. 26 is a diagram illustrating a manner in which the door latch device 1 is shifted from the unset state (upper diagram) to the set state (lower diagram) by driving of a motor 41; and

FIG. 27 is a diagram illustrating a manner in which the door latch device 1 is shifted from the set state to the unset state by manually operating a key cylinder 5.

### DESCRIPTION OF EMBODIMENTS

Hereinafter, a door latch device according to each embodiment of the present disclosure will be described in detail with reference to the accompanying drawings. The drawings are to be viewed in directions of reference signs. The door latch device exemplified here is a vehicle door latch device mounted on left and right doors (including a front door and a rear door) of an automobile. In the drawings, the front of a vehicle is denoted by Fr, the rear is denoted by Rr, an upper side is denoted by U, and a lower side is denoted by D. A vehicle inner side in a left-right direction (vehicle width direction) is denoted by IN, and a vehicle outer side is denoted by OUT. The front, rear, vehicle inner side, and vehicle outer side in the description are directions based on a fully-closed state where the doors are completely closed.

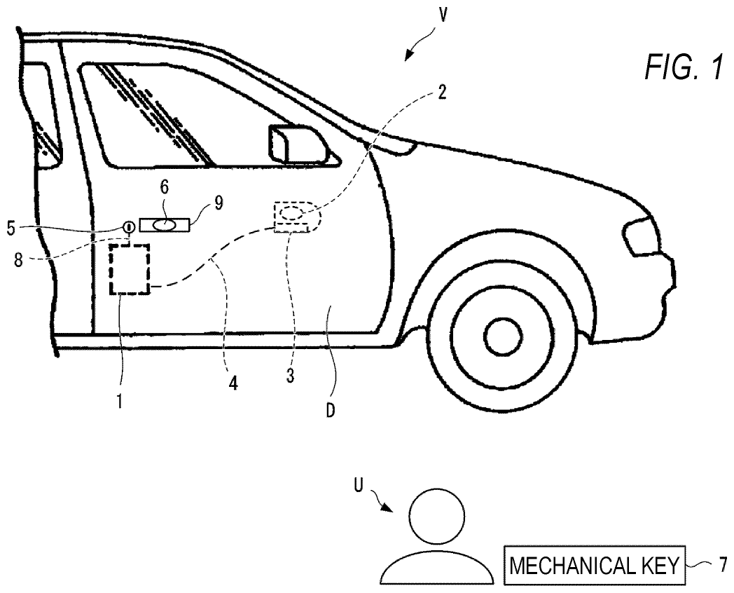

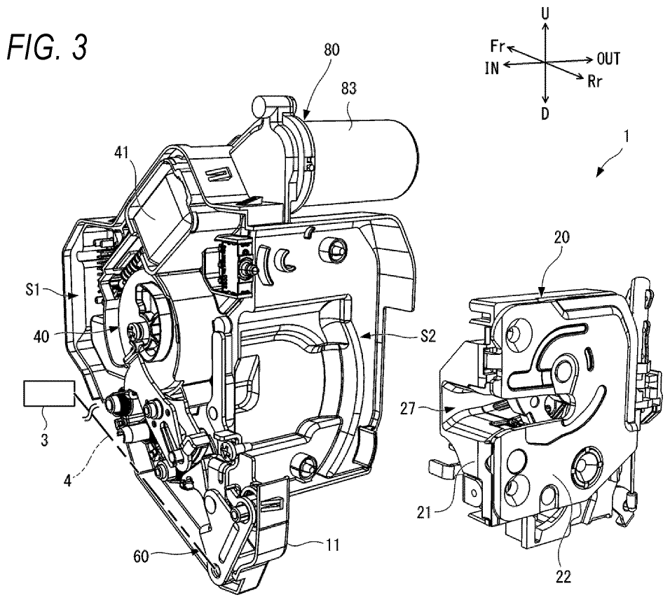

FIG. 1 is a side view of a vehicle V to which a door latch device 1 according to embodiment of the present disclosure is attached. The door latch device 1 is attached to, for example, a rear end inside a right door D of the vehicle V. The door latch device 1 is an electrical door latch device capable of performing an opening operation of the door D by a motor 41 (see FIG. 3 and the like) driven by an operation of a vehicle cabin interior switch 2 provided inside a vehicle cabin or a vehicle cabin exterior switch 6 provided on an outside handle 9 outside the vehicle cabin, and is also called an E latch.

The door latch device 1 can perform the opening operation of the door D not only by the electrical opening operation using the motor 41 but also by a manual operation of a user U. Specifically, the opening operation of the door D can also be performed by a physical operation such as an operation of an inner handle 3 (an example of a vehicle interior operation portion) provided inside the vehicle cabin or an operation using a mechanical key 7 with respect to a key cylinder 5 (an example of a vehicle exterior operation portion) provided outside the vehicle cabin. The opening operation of the door D by the inner handle 3 or the mechanical key 7 is basically performed in an emergency such as power shortage or failure of the motor 41, and the normal opening operation of the door D is electrically performed by the vehicle cabin interior switch 2 or the vehicle cabin exterior switch 6.

### First Embodiment

### [Overall Configuration of Door Latch Device]

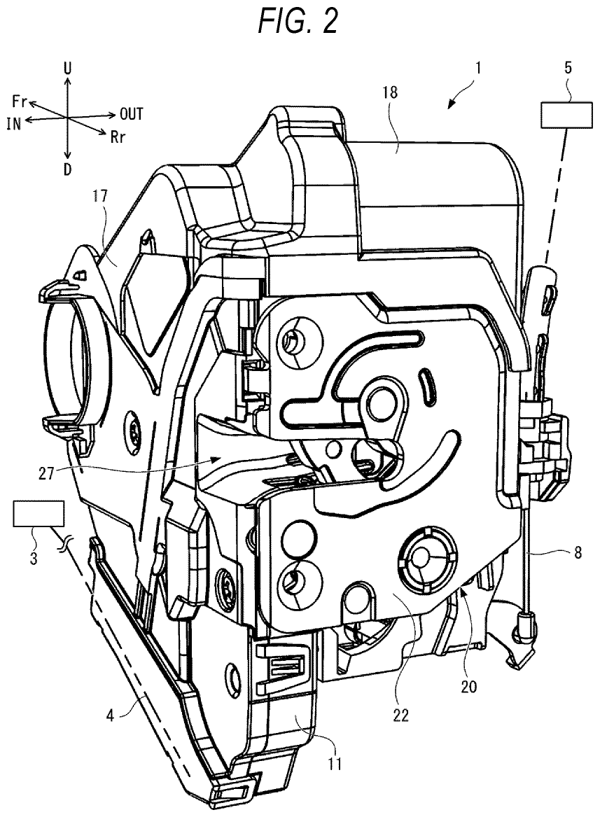

Next, a door latch device 1 according to a first embodiment will be described. As illustrated in FIGS. 2 and 3, the door latch device 1 includes a housing 11 made of a synthetic resin or the like, a latch mechanism 20 that maintains the door D in a closed state with respect to a vehicle body, an electric release mechanism 40 that electrically opens the door D by driving the motor 41, and a manual release mechanism 60 that mechanically opens the door D by a manual operation from a vehicle cabin interior side and a vehicle cabin exterior side. The electric release mechanism 40 and the manual release mechanism 60 are disposed in a space S1 provided on the vehicle inner side of the housing 11, and are accommodated in the housing 11 by being covered with a first cover 17 attached from the vehicle inner side. A latch mechanism 20 is assembled to a space S2 provided on a rear side of the housing 11.

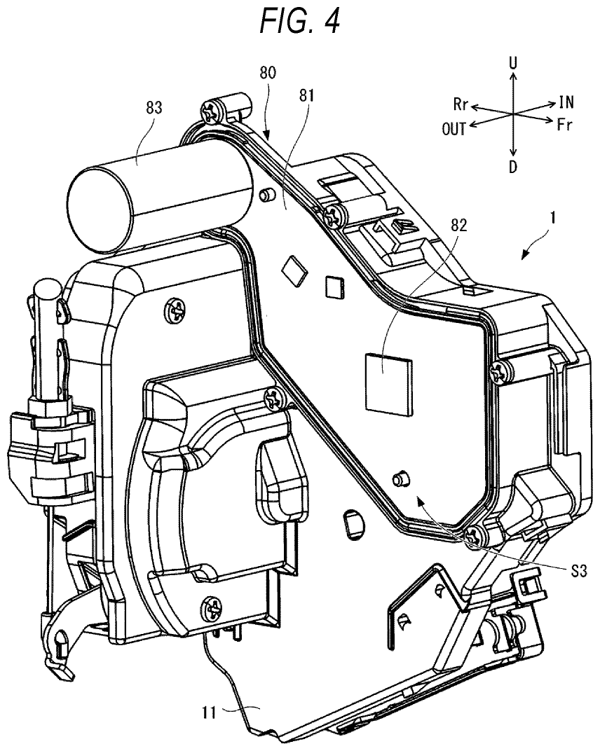

As illustrated in FIGS. 3 and 4, the door latch device 1 further includes an electrical component 80 that operates the electric release mechanism 40. The electrical component 80 includes, for example, a circuit board 81, an electronic control unit (ECU) 82 that is mounted on the circuit board 81 and controls the driving of the motor 41, and a capacitor 83 such as a capacitor that stores power to be supplied to the motor 41 and the ECU 82. The electrical component 80 is disposed in a space S3 provided on an upper side and the vehicle outer side of the housing 11, and is accommodated in the housing 11 by being covered with a second cover 18 attached from above and a third cover (not illustrated) attached from the vehicle outer side.

The motor 41, the ECU 82, and the capacitor 83 are disposed in an upper portion of the door latch device 1, specifically, above a striker entering groove 27 to be described later, thereby preventing the motor 41, the ECU 82, and the capacitor 83 from being exposed to liquids such as rainwater entering from the striker entering groove 27.

### [Latch Mechanism]

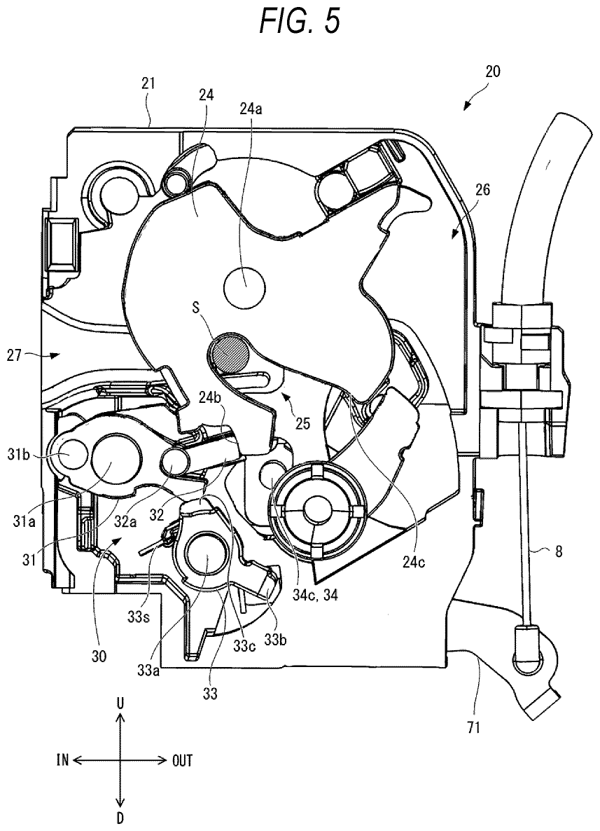

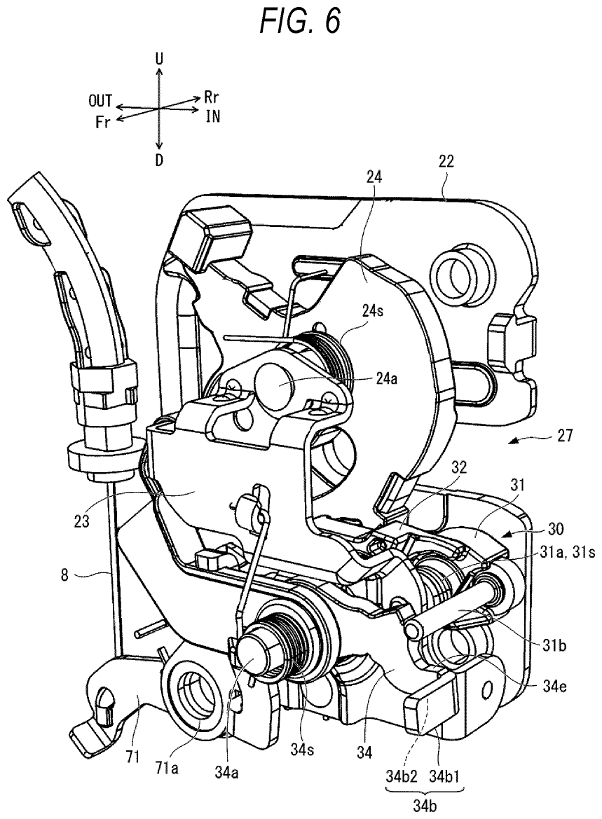

FIG. 5 is a rear view of the latch mechanism 20 as viewed from a rear side, and FIG. 6 is a perspective view of the latch mechanism 20 (body 21 not illustrated) as viewed from a front side. FIGS. 5 and 6 illustrate a state where the latch mechanism 20 is engaged with a striker S provided on the vehicle body.

The latch mechanism 20 includes the body 21 made of a synthetic resin or the like, a metal cover plate 22 disposed on a rear side of the body 21, a metal back plate 23 disposed on a front side of the body 21, a latch 24 that is rotatable around a latch shaft 24a and can be engaged with the striker S provided on the vehicle body when the door D is closed, and a pawl mechanism 30 including a pawl 32 that can be engaged with the latch 24. The latch 24 and the pawl mechanism 30 are supported by the body 21, the cover plate 22, and the back plate 23.

A recessed accommodating portion 26 that accommodates the latch 24 and a part of the pawl mechanism 30 is provided on a rear surface side of the body 21. The cover plate 22 is fixed in the door D by bolts (not illustrated), and is disposed so as to cover the accommodating portion 26 of the body 21. The back plate 23 supports the latch 24, the pawl mechanism 30, and an outer lever 71 to be described later from the front side of the body 21.

The striker entering groove 27 is provided in the body 21 and the cover plate 22 at a substantially central portion in an up-down direction. The striker entering groove 27 is a portion into which the striker S enters when the door D is closed, extends in the vehicle width direction, and opens to the vehicle inner side. The latch 24 is provided above the striker entering groove 27, and the pawl mechanism 30 is provided below the striker entering groove 27.

The latch 24 has an accommodating groove 25 that is recessed from an outer peripheral surface toward the latch shaft 24a and capable of accommodating the striker S. A coil spring 24s is wound around the latch shaft 24a, and the latch 24 is biased in a direction in which the latch 24 is disengaged from the striker S by a biasing force of the coil spring 24s to open the door D, specifically, in a clockwise direction in FIG. 5.

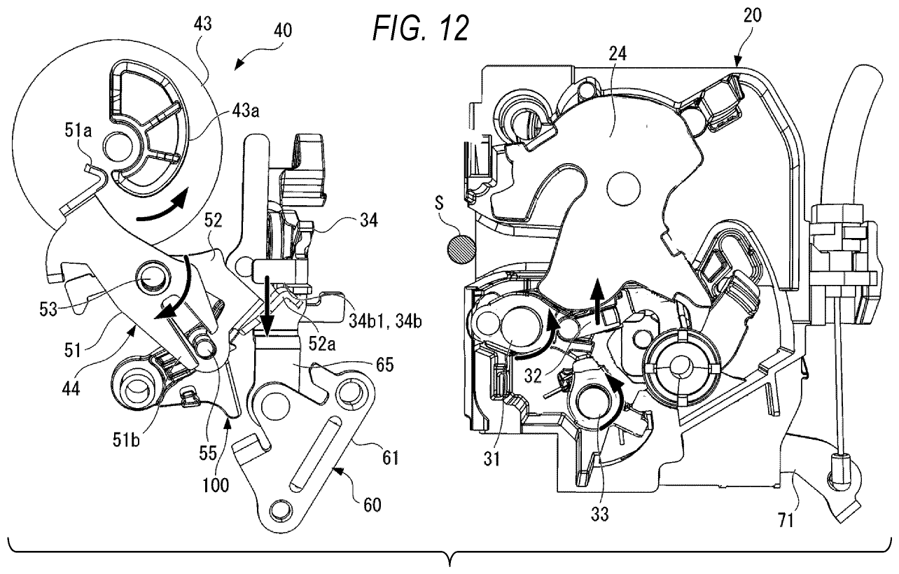

A full-latch engagement portion 24b and a half-latch engagement portion 24c are provided on the outer peripheral surface of the latch 24. When the pawl 32 is engaged with the full-latch engagement portion 24b, the latch 24 is in a full-latched state (see FIG. 5) corresponding to a state where the door D is completely closed. When the pawl 32 is engaged with the half-latch engagement portion 24c, the latch 24 is in a half-latched state (not illustrated) corresponding to a half-door state. The full-latched state and the half-latched state are states in which the latch 24 is locked to the striker S by the pawl 32, and are collectively referred to as a latched state. When the latch 24 is not engaged with the striker S and is not locked to the striker S by the pawl 32, the latch 24 is in an unlatched state (see FIG. 12 and the like) corresponding to a fully opened state where the door D is completely opened.

When the latch 24 is engaged with the striker S, the pawl mechanism 30 maintains the latched state where the latch 24 is locked to the striker S. The pawl mechanism 30 includes a ratchet 31 rotatable around a ratchet shaft 31a, the pawl 32 provided at an end of the ratchet 31 and capable of being engaged with the latch 24, a retaining lever 33 rotatable around a lever shaft 33a, and a pawl lever 34 that transmits a driving force of the motor 41 or an operation force by a manual operation to the pawl 32 to cancel the latched state. In the following description of operation directions of each element of the pawl mechanism 30, the direction in which the pawl 32 is engaged with the latch 24 is also referred to as an “engagement direction”, and the direction in which the pawl 32 is separated and disengaged from the latch 24 is also referred to as a “release direction”.

The ratchet 31, the pawl 32, and the retaining lever 33 are accommodated in the accommodating portion 26 of the body 21, and the pawl lever 34 is disposed in front of the back plate 23.

The ratchet 31 is rotatably supported around the ratchet shaft 31a. The ratchet 31 is biased in the engagement direction (counterclockwise direction in FIG. 5) by a biasing force of a coil spring 31s wound around the ratchet shaft 31a. The ratchet 31 includes an input portion 31b that extends in a front-rear direction and with which the pawl lever 34 can be engaged from below. The input portion 31b receives an input of the driving force of the motor 41 or an operation force by a manual operation via the pawl lever 34.

The pawl 32 is rotatable around a pawl shaft 32a that is inserted through a shaft hole provided at the end of the ratchet 31. The pawl 32 is biased in the engagement direction to be engaged with the latch 24, specifically, in the counterclockwise direction in FIG. 5, by a biasing force of a coil spring (not illustrated) hooked on the ratchet 31, and normally abuts against the outer peripheral surface of the latch 24. When the ratchet 31 rotates in the release direction (clockwise direction in FIG. 5), the pawl 32 rotates in the release direction together with the ratchet 31 against the biasing force of the coil spring.

The retaining lever 33 is provided below the ratchet 31 and is rotatable around the lever shaft 33a. The retaining lever 33 includes an input portion 33b that can be engaged with the pawl lever 34 and receives an input of the driving force of the motor 41 or an operation force by a manual operation via the pawl lever 34, and a retaining portion 33c that abuts against the ratchet 31 from below to prevent the ratchet 31 from rotating in the release direction. The retaining lever 33 is biased in a direction (counterclockwise direction in FIG. 5) in which the retaining portion 33c is engaged with the ratchet 31 by a biasing force of a coil spring 33s wound around the lever shaft 33a. The retaining lever 33 normally abuts against the ratchet 31 from below to prevent the ratchet 31 from rotating in the release direction. On the other hand, when the retaining lever 33 rotates in the release direction (clockwise direction in FIG. 5) by the input received by the input portion 33b, the retaining lever 33 is disengaged from the ratchet 31, allowing the ratchet 31 to rotate in the release direction.

The pawl lever 34 can be engaged with the electric release mechanism 40 and the manual release mechanism 60, and is rotatable around the lever shaft 34a. The pawl lever 34 is biased in the counterclockwise direction in FIG. 5 by a biasing force of a coil spring 34s wound around the lever shaft 34a.

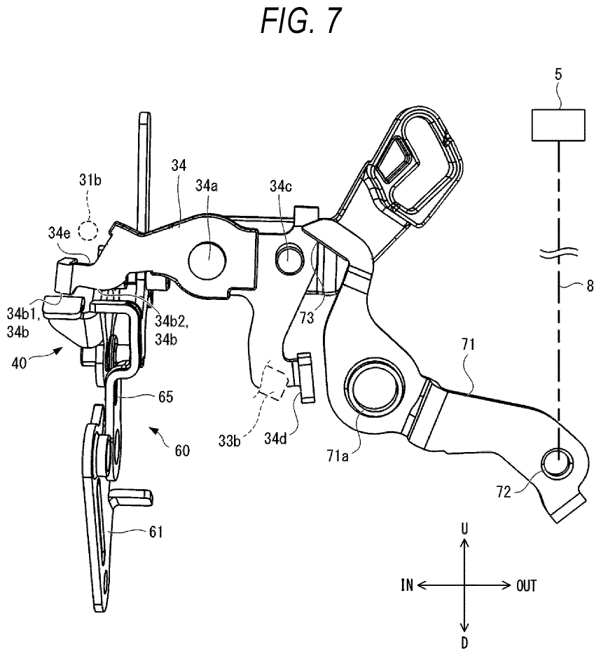

Referring to FIG. 7, the pawl lever 34 includes a first input portion 34b that receives the driving force of the motor 41 and an operation force of the inner handle 3, a second input portion 34c that receives an input of an operation force of the key cylinder 5 provided outside the vehicle, a retaining lever operation portion 34d that can be engaged with the input portion 33b of the retaining lever 33 and rotates the retaining lever 33, and a ratchet operation portion 34e that can be engaged with the input portion 31b of the ratchet 31 and rotates the ratchet 31. The first input portion 34b is provided on the vehicle inner side of the lever shaft 34a, and the second input portion 34c is provided on the vehicle outer side of the lever shaft 34a.

The first input portion 34b of the pawl lever 34 includes an electric side engagement portion 34b 1 that is engaged with the electric release mechanism 40 and receives an input of the driving force of the motor 41, and a manual side engagement portion 34b2 that is engaged with the manual release mechanism 60 and receives an input of the operation force of the inner handle 3. The electric side engagement portion 34bl and the manual side engagement portion 34b2 are provided at different positions.

When the latch 24 is in the latched state and there is a driving force of the motor 41 or an operation force of the inner handle 3, the first input portion 34b is pushed up by the electric release mechanism 40 or the manual release mechanism 60, and the pawl lever 34 rotates around the lever shaft 34a. Accordingly, the retaining lever operation portion 34d is engaged with the input portion 33b of the retaining lever 33, and rotates the retaining lever 33 in the release direction against the biasing force of the coil spring 33s. Subsequently, the ratchet operation portion 34e is engaged with the input portion 31b of the ratchet 31, rotates the ratchet 31 in the release direction against the biasing force of the coil spring 31s, and also rotates the pawl 32 provided in the ratchet 31 in the release direction. Accordingly, the pawl 32 is separated from the latch 24 and is in a non-engaged state (non-abutment state), the latched state is released, and the door D is opened.

The latch mechanism 20 is provided with the outer lever 71 supported by the back plate 23 at a position on the vehicle outer side and a lower side. The outer lever 71 is rotatable about a lever shaft 71a. The outer lever 71 is biased in a direction away from the second input portion 34c of the pawl lever 34, specifically, in a clockwise direction in FIG. 7, by a biasing force of a coil spring (not illustrated) wound around the lever shaft 71a.

The outer lever 71 includes an input portion 72 that is connected to the key cylinder 5 via a cable 8 and receives an input of the operation force of the key cylinder 5, and an operation portion 73 that can be engaged with the second input portion 34c of the pawl lever 34 and rotates the pawl lever 34. The operation portion 73 is provided on the opposite side of the lever shaft 71a from the input portion 72.

When the key cylinder 5 is operated while the latch 24 is in the latched state, the input portion 72 of the outer lever 71 is pulled upward by the cable 8, and the outer lever 71 rotates around the lever shaft 71a. The operation portion 73 of the outer lever 71 is engaged with the second input portion 34c of the pawl lever 34 to press down the second input portion 34c. Accordingly, the pawl lever 34 rotates around the lever shaft 34a, the retaining lever operation portion 34d is engaged with the input portion 33b of the retaining lever 33, and rotates the retaining lever 33 in the release direction against the biasing force of the coil spring 33s. Subsequently, the ratchet operation portion 34e is engaged with the input portion 31b of the ratchet 31, rotates the ratchet 31 in the release direction against the biasing force of the coil spring 31s, and also rotates the pawl 32 provided in the ratchet 31 in the release direction. Accordingly, the pawl 32 is separated from the latch 24 and is in the non-engaged state (non-abutment state), the latched state is released, and the door D is opened.

### [Electric Release Mechanism]

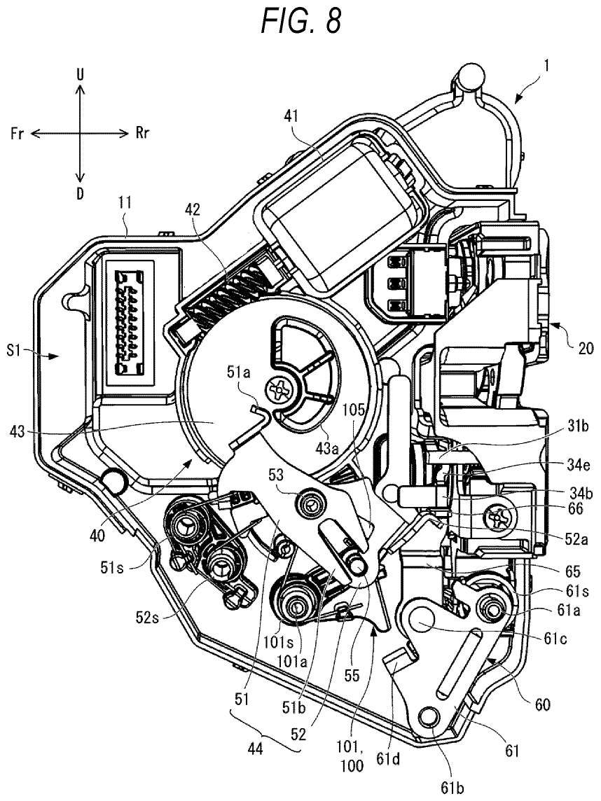

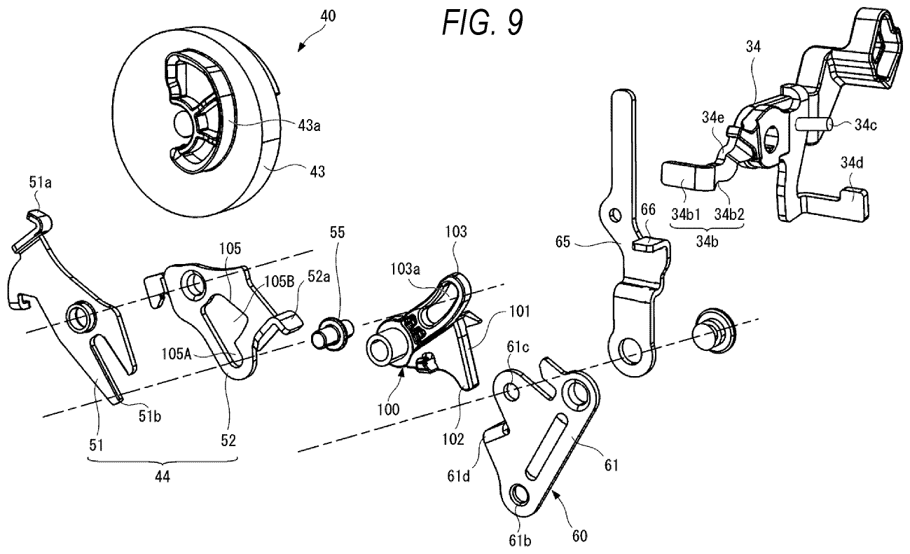

As illustrated in FIGS. 8 and 9, the electric release mechanism 40 includes the motor 41, a worm gear 42 provided on a drive shaft of the motor 41, a cam wheel 43 that meshes with the worm gear 42 via teeth formed on an outer peripheral surface thereof and has a cam portion 43a, and an electric release lever 44 that operates by abutting against the cam portion 43a. The electric release mechanism 40 transmits the driving force of the motor 41 to the pawl lever 34 of the latch mechanism 20 via the worm gear 42, the cam wheel 43, and the electric release lever 44 to cancel the latched state. Each element of the electric release mechanism 40 illustrated in FIG. 8 is in a standby position.

The motor 41 is disposed such that the drive shaft provided with the worm gear 42 faces forward and downward. The motor 41 is driven based on an operation of the vehicle cabin interior switch 2 or the vehicle cabin exterior switch 6. For example, when a speed of the vehicle Vis equal to or higher than a predetermined speed, the ECU 82 controls the motor 41 so as not to drive the motor 41 even if the vehicle cabin interior switch 2 or the vehicle cabin exterior switch 6 is operated.

The cam wheel 43 is rotatable around an axis extending in the vehicle width direction, and is disposed below the motor 41 and the worm gear 42. The cam portion 43a is provided on a surface of the cam wheel 43 on the vehicle inner side and protrudes toward the vehicle inner side. When the cam wheel 43 rotates in a clockwise direction in FIG. 8, a distance between the cam portion 43a and a center of the cam wheel 43 increases. In the following description, the rotation of the cam wheel 43 in the clockwise direction in FIG. 8 is also referred to as forward rotation, and the rotation in a counterclockwise direction is also referred to as reverse rotation. A direction in which the electric release lever 44 moves when the cam wheel 43 rotates forward from the standby position is also referred to as a release direction, and a direction in which the electric release lever 44 moves when the cam wheel 43 rotates reversely toward the standby position is also referred to as a standby direction.

The electric release lever 44 includes a first lever 51 that is operated by driving the motor 41, and a second lever 52 that is engaged with the latch mechanism 20 when in a coupled state of operating in conjunction with the first lever 51. Although details will be described later, the second lever 52 can be shifted between the coupled state where the second lever 52 operates in conjunction with the first lever 51 and a non-coupled state where the second lever 52 operates independently of the first lever 51.

The first lever 51 is rotatable around a lever shaft 53 provided below the cam wheel 43. The first lever 51 includes a cam abutment portion 51a that can abut against the cam portion 43a, and a coupling portion 51b coupled to the second lever 52. The cam abutment portion 51a and the coupling portion 51b are provided on opposite sides with the lever shaft 53 in between. The first lever 51 is disposed such that at least the cam abutment portion 51a overlaps the cam wheel 43 when viewed from an axial direction of the lever shaft 53. The first lever 51 is biased by a biasing force of a coil spring 51s provided in the housing 11 in a direction in which the first lever 51 abuts against the cam portion 43a, specifically, in the clockwise direction in FIG. 8.

The second lever 52 is rotatable around the lever shaft 53, that is, is rotatable coaxially with the first lever 51. The second lever 52 is disposed so as to at least partially overlap the first lever 51 when viewed from the axial direction of the lever shaft 53. The second lever 52 is disposed at a position not overlapping the cam wheel 43 when viewed from the axial direction of the lever shaft 53, and is not directly engaged with the cam wheel 43. The second lever 52 is disposed at a position closer to the pawl lever 34 of the latch mechanism 20 than the first lever 51, and includes, at a rear end thereof, an operation portion 52a that is engaged with the first input portion 34b (electric side engagement portion 34b1) of the pawl lever 34 to operate the pawl lever 34.

The second lever 52 is biased in a direction away from the pawl lever 34 of the latch mechanism 20, specifically, in the clockwise direction in FIG. 8, by a biasing force of a coil spring 52s provided in the housing 11. In a case where the first lever 51 and the second lever 52 are in the coupled state, when the motor 41 rotates forward, the second lever 52 rotates in the counterclockwise direction around the lever shaft 53 against the biasing force of the coil spring 52s, and the operation portion 52a is engaged with the first input portion 34b (electric side engagement portion 34b1) of the pawl lever 34 from below to push up the first input portion 34b.

The second lever 52 can be shifted between the coupled state where the second lever 52 is coupled to the first lever 51 via a coupling pin 55 and operates in conjunction with the first lever 51 and the non-coupled state where the coupling via the coupling pin 55 is released and the second lever 52 operates independently of the first lever 51. Here, first, the coupled state will be described in detail, and the non-coupled state will be described together with a cancellation mechanism 100 to be described later.

The second lever 52 is formed with a through hole 105 that penetrates in the axial direction of the lever shaft 53 and through which the coupling pin 55 is inserted. The through hole 105 is divided into a coupling region 105A formed to be slightly larger than a diameter dimension of the coupling pin 55, and a non-coupling region 105B provided continuously from the coupling region 105A and larger than the coupling region 105A. When the coupling pin 55 is located in the coupling region 105A, the second lever 52 is in the coupled state, and when the coupling pin 55 is located in the non-coupling region 105B, the second lever 52 is in the non-coupled state. The coupling region 105A is provided at a position farther from the lever shaft 53 than the non-coupling region 105B, and is provided on a clockwise side in a rotation direction. The coupling portion 51b of the first lever 51 has a substantially U-shaped notch into which the coupling pin 55 can enter. In a case where the coupling pin 55 is located in the coupling region 105A, the coupling portion 51b rotates the second lever 52 in the release direction together with the coupling pin 55 when the first lever 51 rotates in the release direction (counterclockwise direction) around the lever shaft 53.

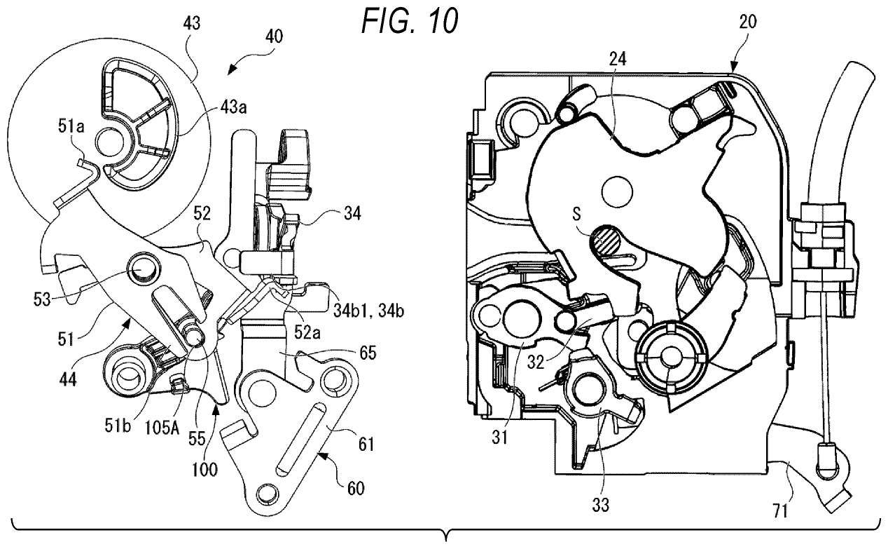

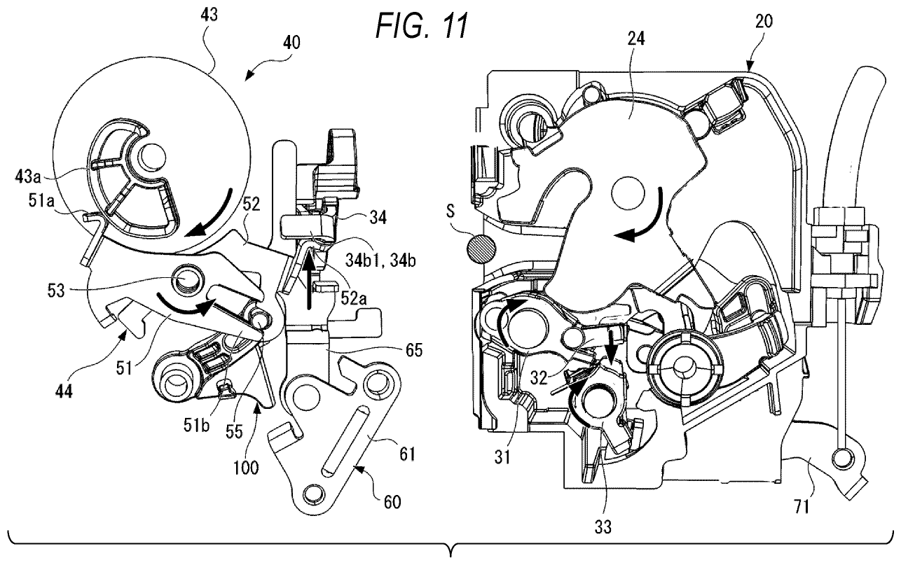

FIGS. 10 to 12 are diagrams illustrating an operation of the electric release mechanism 40 (left side in each figure) and an operation of the latch mechanism 20 (right side in each figure) when the opening operation of the door D is performed by the electric release mechanism 40. Thick arrows in FIGS. 11 and 12 indicate an operation direction of each element.

When the cam wheel 43 rotates forward from the standby position and the first lever 51 rotates in the release direction, the coupling portion 51b of the first lever 51 pushes up the coupling pin 55 and rotates the second lever 52 in the coupled state in the release direction. The operation portion 52a of the second lever 52 pushes up the first input portion 34b (electric side engagement portion 34b1) of the pawl lever 34. When the first input portion 34b is pushed up, as described above, the pawl 32 is in the non-abutment state of being separated from the latch 24, the latched state is canceld, and the door D is opened.

When the cam wheel 43 rotates reversely to return to the standby position after the door D is opened, the first lever 51 and the second lever 52 rotate in the standby direction around the lever shaft 53 by the biasing forces of the coil springs 51s and 52s, respectively, and return to the standby position. At this time, since the operation portion 52a of the second lever 52 moves downward, the push-up state of the first input portion 34b (electric side engagement portion 34b1) of the pawl lever 34 by the operation portion 52a is canceled. Therefore, the pawl 32 abuts against the outer peripheral surface of the latch 24 by the biasing force of the coil spring, and can be engaged with the latch 24 when the door D is closed.

### [Manual Release Mechanism]

Returning to FIGS. 8 and 9, the manual release mechanism 60 includes the inner lever 61 that moves by manually operating the inner handle 3, a link member 65 that is coupled to the inner lever 61 and can be engaged with the pawl lever 34, and the outer lever 71 (see FIG. 7 and the like) that moves by manually operating the key cylinder 5 provided outside the vehicle cabin.

The inner lever 61 is disposed below and to the rear of the electric release mechanism 40. The inner lever 61 is supported by the housing 11 so as to be rotatable around a lever shaft 61a provided at an upper portion thereof. The inner lever 61 is biased in a direction toward the standby position (counterclockwise direction in FIG. 8) by a biasing force of a coil spring 61s provided in the housing 11.

The inner lever 61 includes an input portion 61b that is connected to the inner handle 3 via the cable 4 (see FIG. 3) and receives an input of the operation force from the inner handle 3, and a latch release portion 61c that transmits the operation force of the inner handle 3 to the pawl lever 34 via the link member 65 to cancel the latched state. The input portion 61b is provided at a lower end of the inner lever 61 and receives an input of the operation force of the inner handle 3. The latch release portion 61c is provided between the lever shaft 61a and the input portion 61b, and the link member 65 is connected to the latch release portion 61c.

The link member 65 extends in the up-down direction, and a lower end thereof is connected to the latch release portion 61c of the inner lever 61. The link member 65 includes an operation portion 66 that is engaged with the first input portion 34b (manual side engagement portion 34b2) of the pawl lever 34 to operate the pawl lever 34.

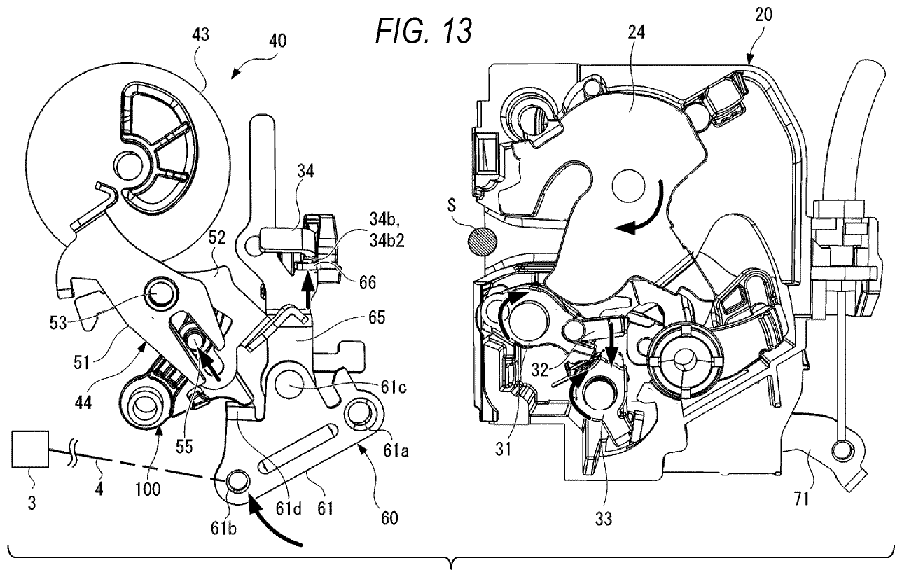

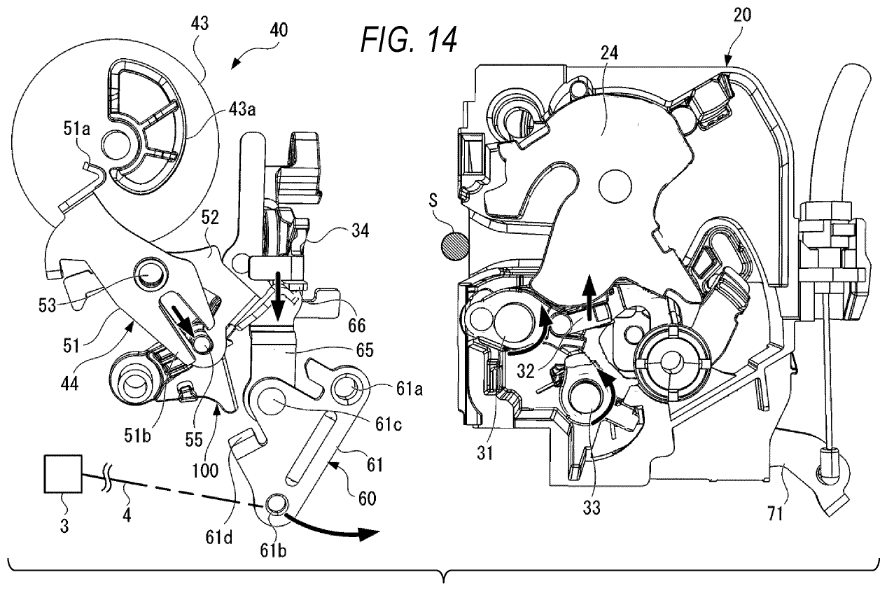

FIGS. 13 and 14 are diagrams illustrating an operation of the manual release mechanism 60 (left side in each figure) and an operation of the latch mechanism 20 (right side in each figure) when the opening operation of the door D is performed by the manual release mechanism 60. Thick arrows in FIGS. 13 and 14 indicate an operation direction of each element.

When the operation force of the inner handle 3 is input to the input portion 61b, the inner lever 61 rotates in the release direction (clockwise direction) around the lever shaft 61a against the biasing force of the coil spring 61s. The link member 65 moves upward in conjunction with the inner lever 61, and the operation portion 66 of the link member 65 is engaged with the first input portion 34b (manual side engagement portion 34b2) of the pawl lever 34 to push up the first input portion 34b. When the first input portion 34b is pushed up, as described above, the pawl 32 is in the non-abutment state of being separated from the latch 24, the latched state is released, and the door D is opened.

After the door D is opened, when the operation force of the inner handle 3 is released, the inner lever 61 returns to the standby position by the biasing force of the coil spring 61s. At this time, since the operation portion 66 of the link member 65 moves downward, the push-up state of the first input portion 34b (manual side engagement portion 34b2) of the pawl lever 34 by the operation portion 66 is canceled. Therefore, the pawl 32 abuts against the outer peripheral surface of the latch 24 by the biasing force of the coil spring, and can be engaged with the latch 24 when the door D is closed.

Here, an operation of the coupling pin 55 when the latched state is canceled by the operation of the inner handle 3 will be described. When the inner lever 61 rotates in the release direction, a cancellation lever 101 also rotates in the counterclockwise direction to move the coupling pin 55. At this time, the coupling pin 55 temporarily moves from the coupling region 105A to the non-coupling region 105B. When the inner lever 61 returns to the standby position, the cancellation lever 101 also returns to the standby position in conjunction therewith, and the coupling pin 55 moves from the non-coupling region 105B to the coupling region 105A.

### [Cancellation Mechanism]

When the latched state is canceled by an operation of the electric release mechanism 40, as illustrated in FIG. 11, the operation portion 52a of the second lever 52 pushes up the first input portion 34b (electric side engagement portion 34b1) of the pawl lever 34. A position of each element of the electric release mechanism 40 in this state will also be referred to as an operation position in the following description. If the motor 41 is stuck (becomes unable to be driven) due to power shortage, failure, or the like when each element of the electric release mechanism 40 is in the operation position, a state where the pawl 32 does not abut against the latch 24 is maintained. When this state is maintained, even if the door D is moved in a closing direction, the latch 24 cannot be locked to the striker S (hereinafter, also referred to as a latch disabled state), and the door D cannot be closed.

Therefore, the door latch device 1 further includes the cancellation mechanism 100 that can be engaged with the inner lever 61 and canceles the latch disabled state by manually operating the inner handle 3 when the latch disabled state is maintained.

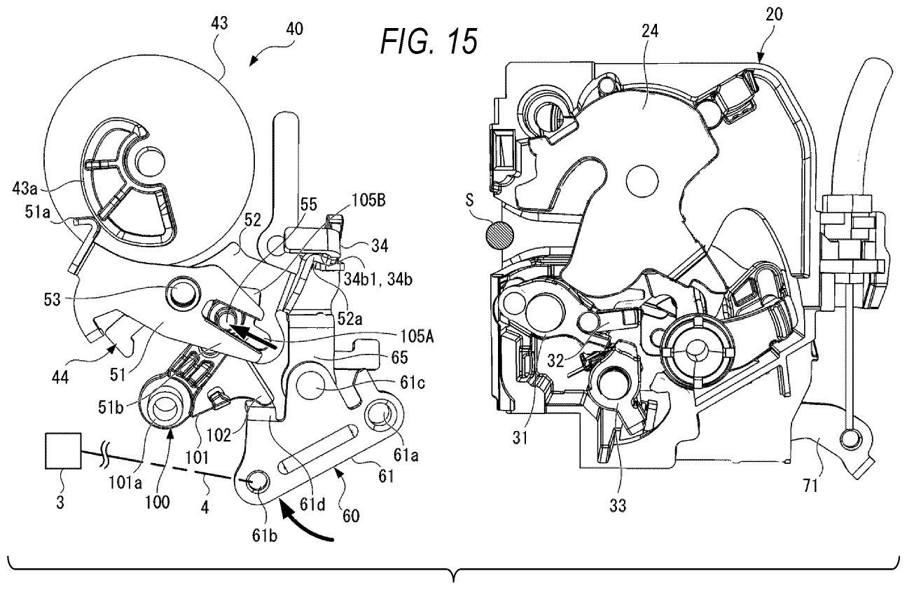

As illustrated in FIGS. 15 to 17, the cancellation mechanism 100 cancels the coupled state of the first lever 51 and the second lever 52 by the operation force of the inner handle 3 transmitted via the inner lever 61, thereby allowing the second lever 52 to retract from the operation position. As the second lever 52 retracts, the engagement between the operation portion 52a and the first input portion 34b (electric side engagement portion 34b1) of the pawl lever 34 is released, and the latch disabled state is canceled.

In this manner, the cancellation mechanism 100 cancels the latch disabled state by moving the second lever 52 stuck in the operation position, through manual operation of the inner handle 3. Therefore, even if the latch disabled state occurs due to power shortage, failure, or the like, the door D can be reliably closed by the manual operation from inside the vehicle cabin, the antitheft performance is improved, and the reliability of the door latch device 1 can be improved.

The cancellation mechanism 100 is provided independently of the motor 41. Specifically, since the cancellation mechanism 100 does not operate by driving the motor 41 but is provided independently of the motor 41 and the cam wheel 43, the cancellation mechanism 100 is not affected by the motor 41 when operated by the operation force of the inner handle 3. Therefore, even if each element of the electric release mechanism 40, including the motor 41, is stuck in the operation position, the cancellation mechanism 100 does not receive large frictional resistance caused by the sticking when operated by the operation force of the inner handle 3, and thus the latch disabled state can be canceled with good operability.

Next, a specific configuration of the cancellation mechanism 100 will be described in detail together with configurations of the inner lever 61 and the electric release lever 44.

As illustrated in FIGS. 8 and 9, the inner lever 61 further includes a cancel operation portion 61d that operates the cancellation mechanism 100 in addition to the latch release portion 61c described above. The cancel operation portion 61d is provided between the input portion 61b and the latch release portion 61c, and transmits the operation force of the inner handle 3 to the cancellation mechanism 100 to operate the cancellation mechanism 100. Since the inner lever 61 includes the latch release portion 61c and the cancel operation portion 61d, the release of the latched state and the operation of the cancellation mechanism 100 can be performed using the common inner lever 61. Therefore, in the door latch device 1, the number of components can be reduced.

The cancellation mechanism 100 includes the cancellation lever 101 that moves by being pressed against the cancel operation portion 61d of the inner lever 61. The cancellation lever 101 is provided between the inner lever 61 and the electric release lever 44. The cancellation lever 101 is rotatable around a lever shaft 101a provided below the electric release lever 44, and at least a part of the cancellation lever 101 overlaps the electric release lever 44 when viewed from an axial direction. The cancellation lever 101 is biased in the clockwise direction in FIG. 8 by a biasing force of a coil spring 101s provided in the housing 11.

The cancellation lever 101 can be engaged with the cancel operation portion 61d of the inner lever 61, and includes an input portion 102 that receives an input of the operation force of the inner handle 3 via the inner lever 61, and a pin holding portion 103 that holds the coupling pin 55. When the inner lever 61 rotates in the clockwise direction by the manual operation of the inner handle 3, the cancellation lever 101 moves by the input portion 102 being pressed against the cancel operation portion 61d of the inner lever 61, and rotates in the counterclockwise direction against the biasing force of the coil spring 101s.

The cancellation lever 101 does not normally move by driving the motor 41. Specifically, the pin holding portion 103 is formed with an elongated hole 103a that allows the coupling pin 55 to move. The elongated hole 103a is formed along a rotation direction of the first lever 51, and when the cancellation lever 101 is in the standby position, a movement trajectory of the coupling pin 55 by the driving of the motor 41 coincides with the elongated hole 103a. Therefore, even if the motor 41 is driven, only the coupling pin 55 moves in the elongated hole 103a, and the cancellation lever 101 does not operate.

The cancellation lever 101 moves the coupling pin 55 to cancel the coupled state of the second lever 52 and bring the second lever 52 into the non-coupled state, and allows the second lever 52 to retract from the operation position.

Referring to FIGS. 15 to 17, when the cancellation lever 101 is pressed against the inner lever 61 and moves, the coupling pin 55 moves from the coupling region 105A to the non-coupling region 105B formed in the second lever 52 (see FIG. 15). When the coupling pin 55 moves to the non-coupling region 105B, the second lever 52 is shifted to the non-coupled state where the second lever 52 is not interlocked with the first lever 51, and can operate independently of the first lever 51.

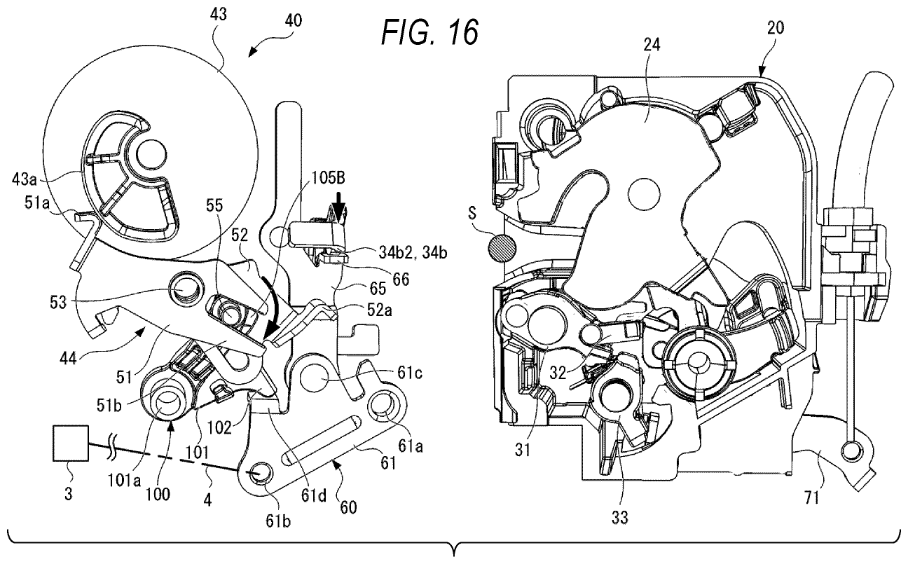

The second lever 52 rotates in the clockwise direction toward the standby position by the biasing force of the coil spring 52s, and the engagement between the operation portion 52a and the first input portion 34b (electric side engagement portion 34b 1) of the pawl lever 34 is released (see FIG. 16). At this time, the operation portion 66 of the link member 65 moves upward from the standby position by the operation of the inner lever 61 and approaches the first input portion 34b (manual side engagement portion 34b2) of the pawl lever 34. Therefore, the manual side engagement portion 34b2 of the pawl lever 34 is received by the operation portion 66 of the link member 65 at a position close to the position where the engagement between the operation portion 52a and the electric side engagement portion 34b 1 of the pawl lever 34 is released. As described above, even after the engagement with the operation portion 52a of the second lever 52 is released, the pawl lever 34 is prevented from rotating forcefully to the standby position, the impact applied to the pawl lever 34 can be prevented, and the generation of impact noise can be prevented.

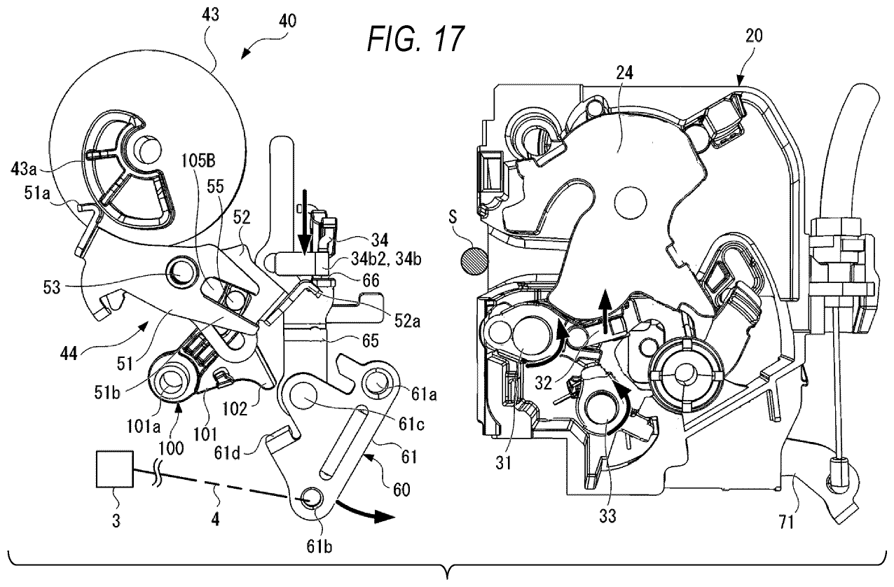

The first input portion 34b (manual side engagement portion 34b2) of the pawl lever 34 received by the operation portion 66 of the link member 65 moves downward and returns to the standby position as the inner lever 61 returns to the standby position by the operation of the inner handle 3 (see FIG. 17). Accordingly, the pawl 32 is shifted to a state of abutting against the latch 24, and the latch disabled state is canceled.

As described above, the cancellation mechanism 100 includes the cancellation lever 101, the coupling pin 55, and the through hole 105 formed in the second lever 52, and allows the second lever 52 to operate independently of the first lever 51 without the interlocking by the operation of the inner handle 3. Since the cancellation lever 101 can shift the first lever 51 and the second lever 52 from the coupled state to the non-coupled state only by moving the coupling pin 55, the latch disabled state can be reliably canceled with good operability. Since the coupling pin 55 is disposed within a projected area of the first lever 51 and the second lever 52, the cancellation mechanism 100 can be implemented that cancels the latch disabled state within a limited range in the housing 11, and the door latch device 1 can be simplified.

As described above, since the cancellation lever 101 includes the pin holding portion 103 that holds the coupling pin 55, the coupling pin 55 moves integrally with the cancellation lever 101 when the cancellation lever 101 is operated. Therefore, the responsiveness of the operation for canceling the latch disabled state is improved.

In the first input portion 34b of the pawl lever 34, the electric side engagement portion 34b1 with which the electric release mechanism 40 is engaged and the manual side engagement portion 34b2 with which the manual release mechanism 60 is engaged are provided at different positions. According to such a configuration, the electric release mechanism 40 does not affect a transmission path of the operation force of the inner handle 3 from the manual release mechanism 60 to the pawl lever 34. Therefore, even if the state where the motor 41 is not driven continues after the latch disabled state is canceled, the latched state can always be canceled by a manual operation from inside the vehicle cabin, and the reliability of the door latch device 1 can be improved.

In the door latch device 1 according to the first embodiment, the motor 41, the ECU 82, and the capacitor 83 are disposed at positions above the striker entering groove 27 and closer to the latch 24 than the pawl 32. The manual release mechanism 60 and the cancellation mechanism 100 are disposed at positions closer to the pawl 32 than the latch 24 at a position below the striker entering groove 27. Since the manual release mechanism 60 and the cancellation mechanism 100 are disposed at positions close to the pawl 32, the configuration for transmitting the operation force of the inner handle 3 to the pawl 32 can be simplified. Since the electrical components such as the motor 41, the ECU 82, and the capacitor 83 are disposed at positions close to the latch 24 disposed above the pawl 32, it is possible to prevent the electrical components from being exposed to liquids such as rainwater. As described above, since the arrangement of each element of the door latch device 1 is optimized, the door latch device 1 can be downsized.

### Second Embodiment

Next, the door latch device 1 according to a second embodiment will be described. The door latch device 1 according to the second embodiment further includes a vehicle interior operation disabling mechanism 200 capable of disabling an operation of an inner handle 3. Hereinafter, a configuration of the vehicle interior operation disabling mechanism 200 will be mainly described in detail. In the door latch device 1 according to the second embodiment, since the configurations of the latch mechanism 20 excluding the pawl lever 34 and the electric release mechanism 40 are the same as those of the door latch device 1 according to the first embodiment, descriptions and illustrations thereof may be appropriately omitted.

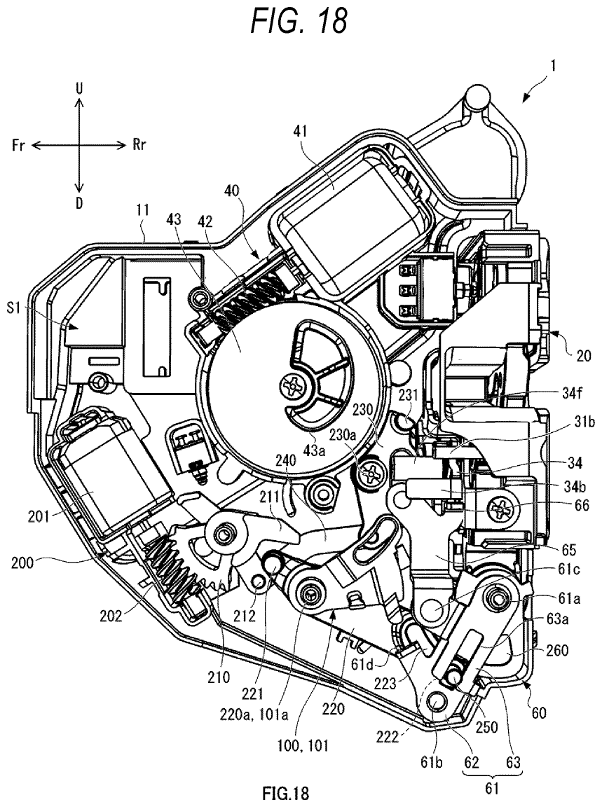

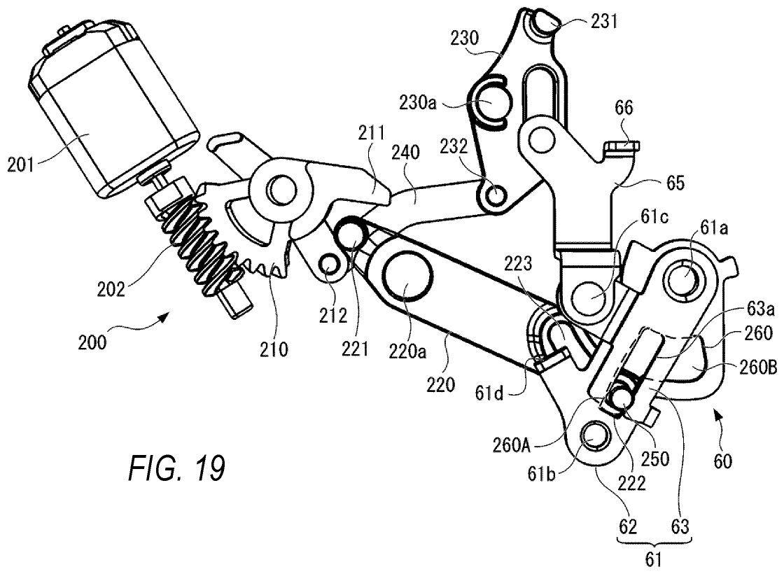

FIG. 18 is a view of the vehicle interior operation disabling mechanism 200 according to the second embodiment accommodated in the space S1 of the housing 11 as viewed from the vehicle inner side. Although the electric release lever 44 (first lever 51 and second lever 52) of the electric release mechanism 40 is disposed on the vehicle inner side with respect to each element of the vehicle interior operation disabling mechanism 200, the electric release lever 44 of the electric release mechanism 40 is omitted in FIG. 18 in order to describe the configuration of the vehicle interior operation disabling mechanism 200. FIG. 19 is an enlarged view of the vehicle interior operation disabling mechanism 200 and the manual release mechanism 60.

Before describing the vehicle interior operation disabling mechanism 200, first, the inner lever 61 of the manual release mechanism 60 according to the second embodiment will be described.

The inner lever 61 according to the second embodiment includes a cancel operation lever 62 that moves by manually operating the inner handle 3 and transmits an operation force of the inner handle 3 to the cancellation mechanism 100, and a latch release lever 63 that transmits the operation force of the inner handle 3 to the latch mechanism 20 to cancel a latched state when in a coupled state of operating in conjunction with the cancel operation lever 62. The cancel operation lever 62 and the latch release lever 63 are both rotatable around a common lever shaft 61a, and partially overlap each other when viewed from an axial direction of the lever shaft 61a.

Similarly to the inner lever 61 according to the first embodiment, the cancel operation lever 62 includes the input portion 61b and the cancel operation portion 61d, and operates the cancellation mechanism 100 by the operation of the inner handle 3 when a latch disabled state occurs.

The cancel operation lever 62 is formed with a through hole 260 that penetrates in the axial direction of the lever shaft 61a and through which a pin 250 is inserted. The through hole 260 is divided into an unset region 260A having a width slightly larger than a dimension of the pin 250, and a set region 260B provided continuously from the unset region 260A and larger than the unset region 260A. The unset region 260A is formed below the set region 260B. The set region 260B is formed to extend in a rotation direction of the latch release lever 63.

The latch release lever 63 includes a latch release portion 61c and a coupling portion 63a coupled to the cancel operation lever 62 via the pin 250. The latch release portion 61c is similar to the latch release portion 61c of the inner lever 61 according to the first embodiment, and is connected to a link member 65.

The coupling portion 63a is formed with a substantially U-shaped notch and holds the pin 250 held by a pin operation lever 220 to be described later. The coupling portion 63a extends from the unset region 260A to the set region 260B of the through hole 260 formed in the cancel operation lever 62, and allows the held pin 250 to move between the unset region 260A and the set region 260B.

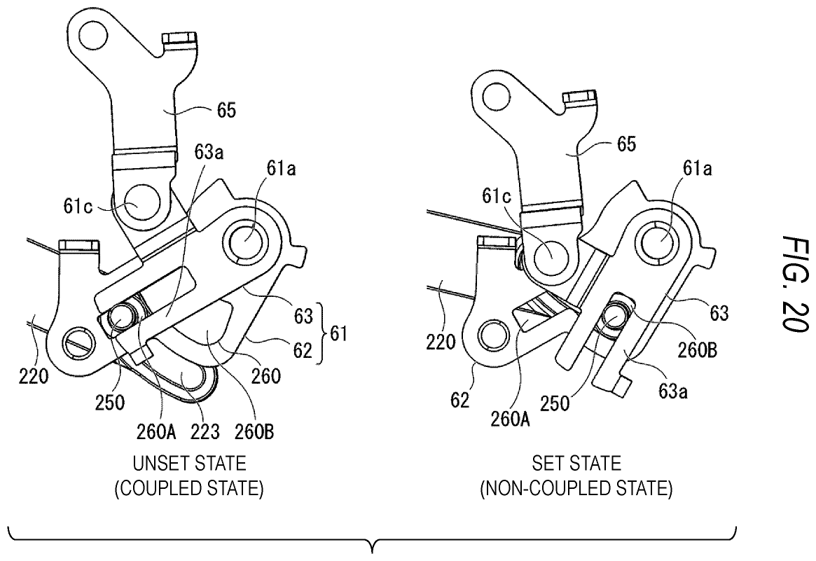

As illustrated in FIG. 20, the latch release lever 63 can be shifted between a coupled state (left side) in which the latch release lever 63 is coupled to the cancel operation lever 62 via the pin 250 and operates in conjunction with the cancel operation lever 62 and a non-coupled state (right side) in which the coupling via the pin 250 is released and the latch release lever 63 does not operate in conjunction with the cancel operation lever 62. The cancel operation lever 62 illustrated in FIG. 20 is in a state where the cancel operation lever 62 has been rotated in a release direction by the operation of the inner handle 3.

When the pin 250 is disposed in the unset region 260A of the through hole 260, the cancel operation lever 62 and the latch release lever 63 are in the coupled state. When the inner handle 3 is manually operated in the coupled state, the latch release lever 63 operates in conjunction with the cancel operation lever 62 and rotates around the lever shaft 61a together with the cancel operation lever 62. The link member 65 moves upward in conjunction with the latch release lever 63, and the operation portion 66 of the link member 65 is engaged with the first input portion 34b (manual side engagement portion 34b2) of the pawl lever 34 to push up the first input portion 34b. When the first input portion 34b is pushed up, the pawl 32 is separated from the latch 24 (non-abutment state), the latched state is released, and the door D is opened. As described above, a state where the operation force of the inner handle 3 can be transmitted from the manual release mechanism 60 to the latch mechanism 20 is also referred to as an “unset state”.

On the other hand, when the pin 250 is disposed in the set region 260B of the through hole 260, the cancel operation lever 62 and the latch release lever 63 are in the non-coupled state. Even if the inner handle 3 is manually operated in the non-coupled state, the latch release lever 63 does not operate in conjunction with the cancel operation lever 62. That is, in the non-coupled state, the operation of the inner handle 3 is disabled, and the latched state is maintained. A state where the operation force of the inner handle 3 cannot be transmitted from the manual release mechanism 60 to the latch mechanism 20 is also referred to as a “set state”.

In the set state, the latch release lever 63 cannot transmit the operation force of the inner handle 3 to the latch mechanism 20, but the cancel operation lever 62 can transmit the operation force of the inner handle 3 to the cancellation mechanism 100. This is because the cancel operation lever 62 is provided with the input portion 61b that receives an input of the operation force of the inner handle 3 via the cable 4, and the cancel operation lever 62 can be engaged with the cancellation mechanism 100 regardless of the coupled state or the non-coupled state.

Returning to FIGS. 18 and 19, the vehicle interior operation disabling mechanism 200 will be described. The vehicle interior operation disabling mechanism 200 selectively switches between the set state and the unset state described above.

The vehicle interior operation disabling mechanism 200 includes a motor 201, a worm gear 202 provided on a drive shaft of the motor 201, a sector gear 210 that meshes with the worm gear 202 via teeth formed on an outer peripheral surface thereof, a pin operation lever 220 that operates in conjunction with the sector gear 210 and operates the pin 250, an interlocking lever 230 that can be engaged with the pawl lever 34 and operates in conjunction with the pawl lever 34, and a link member 240 that couples the interlocking lever 230 and the sector gear 210.

The motor 201 is disposed on a front side in the space S1 of the housing 11, and is disposed such that the shaft provided with the worm gear 202 faces rearward and downward. The motor 201 is driven based on, for example, an operation of a switch provided inside the vehicle cabin interior, a switch provided outside the vehicle cabin interior, or a remote operation switch carried by a user U (none of which are illustrated). The ECU 82 can control the motor 201 in addition to the motor 41.

The sector gear 210 is rotatable around an axis extending in the vehicle width direction, and is disposed on a rear side of the motor 201 and the worm gear 202. In the following description, rotation of the sector gear 210 in a clockwise direction in FIG. 19 is also referred to as forward rotation, and rotation in a counterclockwise direction is also referred to as reverse rotation.

The sector gear 210 is provided with a lever engagement portion 211 that can be engaged with the pin operation lever 220 and a link connection portion 212 to which the link member 240 is connected. When the sector gear 210 rotates forward from a standby position, the lever engagement portion 211 is engaged with the pin operation lever 220 to operate the pin operation lever 220.

The pin operation lever 220 is provided between the inner lever 61 of the manual release mechanism 60 and the sector gear 210, and extends in a front-rear direction. The pin operation lever 220 is rotatable around a lever shaft 220a, and is biased in the clockwise direction in FIG. 19 by a biasing force of a coil spring (not illustrated) provided in the housing 11. Here, an example is shown in which the lever shaft 220a of the pin operation lever 220 coincides (is coaxial) with the lever shaft 101a of the cancellation lever 101, but the lever shaft 220a of the pin operation lever 220 and the lever shaft 101a of the cancellation lever 101 may not be coaxial.

The pin operation lever 220 includes an input portion 221 that can be engaged with the lever engagement portion 211 of the sector gear 210 and receives an input of a driving force of the motor 201 via the sector gear 210, and a pin operation portion 222 that moves the pin 250 in accordance with the rotation of the pin operation lever 220. The pin operation lever 220 selectively switches between the set state and the unset state by moving the pin 250.

A guide groove 223 through which the pin 250 is inserted and which extends in a rotation direction of the cancel operation lever 62 is formed in the pin operation portion 222. The pin operation portion 222 holds the pin 250 provided movably along the guide groove 223.

The interlocking lever 230 is disposed above the pin operation lever 220 and the inner lever 61 and is rotatable around a lever shaft 230a. The interlocking lever 230 includes an input portion 231 that can be engaged with the pawl lever 34 and receives an input of an operation force from a key cylinder 5 via the outer lever 71 and the pawl lever 34, and a connection portion 232 that is connected to the link connection portion 212 of the sector gear 210 via the link member 240. The input portion 231 is provided on the opposite side of the connection portion 232 with the lever shaft 230a in between.

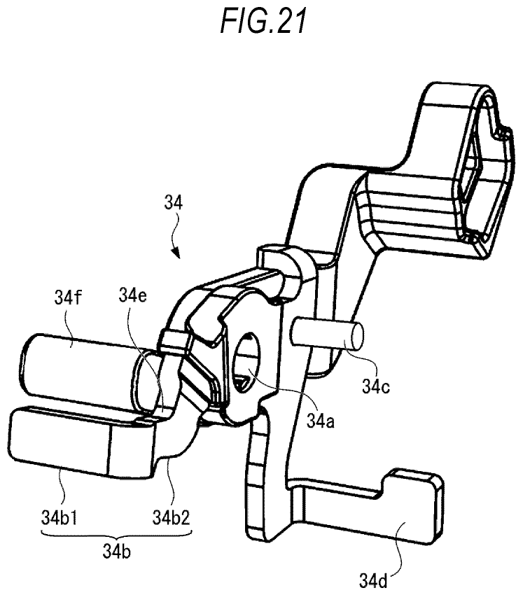

As illustrated in FIG. 21, the pawl lever 34 according to the second embodiment further includes an interlocking lever operation portion 34f that can be engaged with the input portion 231 of the interlocking lever 230 and operates the interlocking lever 230. The interlocking lever operation portion 34f is engaged with the input portion 231 of the interlocking lever 230 from below and pushes up the input portion 231 to rotate the interlocking lever 230 around the lever shaft 230a.

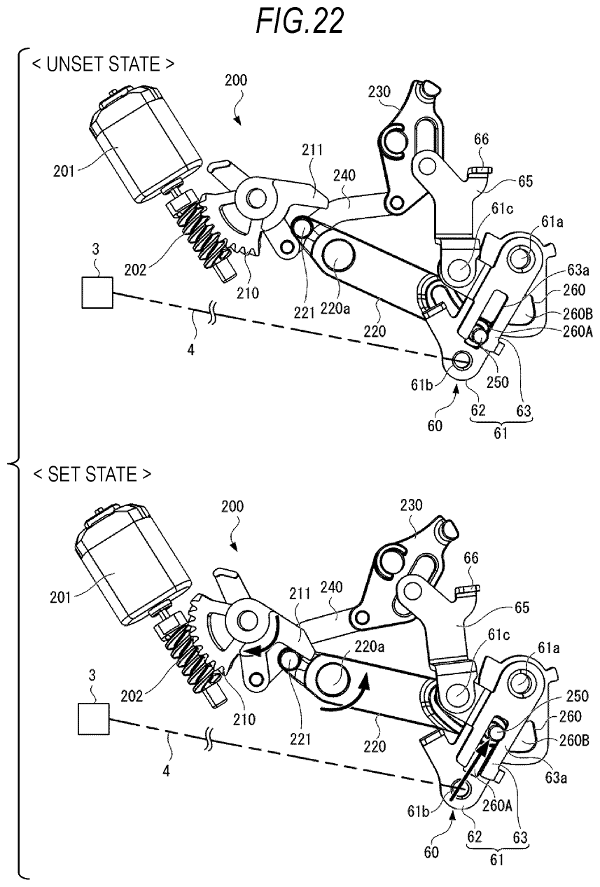

FIG. 22 is a diagram illustrating a manner in which the door latch device 1 is shifted from the unset state (upper diagram) to the set state (lower diagram) by driving of the motor 201. In a case where the door latch device 1 is in the unset state, when the motor 201 is driven to rotate the sector gear 210 forward, the lever engagement portion 211 of the sector gear 210 is engaged with the input portion 221 of the pin operation lever 220 and pushes down the input portion 221 as indicated by a thick arrow. The pin operation lever 220 rotates in the counterclockwise direction around the lever shaft 220a to move the pin 250 from the unset region 260A to the set region 260B. In this manner, the vehicle interior operation disabling mechanism 200 switches from the unset state to the set state by driving the motor 201.

Conversely, when switching from the set state to the unset state, the motor 201 is driven such that the sector gear 210 rotates reversely. Accordingly, the engagement between the lever engagement portion 211 of the sector gear 210 and the input portion 221 of the pin operation lever 220 is released, and the pin operation lever 220 rotates in the clockwise direction around the lever shaft 220a by a biasing force of a coil spring (not illustrated) to move the pin 250 from the set region 260B to the unset region 260A.

As described above, since the door latch device 1 according to the second embodiment further includes the vehicle interior operation disabling mechanism 200 that selectively switches between the set state and the unset state, it is possible to further improve the antitheft performance and the safety. Specifically, for example, by setting the door latch device 1 in the set state during parking, the door D does not open even if a window attached to the door D is broken and the inner handle 3 is operated from outside the vehicle cabin. Therefore, the antitheft performance is sufficiently ensured. For example, by setting the door latch device 1 in the set state during traveling, the door D does not open even if the inner handle 3 is unexpectedly operated, and thus the safety can be improved.

The vehicle interior operation disabling mechanism 200 electrically switches between the set state and the unset state by driving the motor 201, which is highly convenient.

Since the pin operation lever 220 selectively switches between the set state and the unset state by moving the pin 250, the state can be switched with good operability.

The lever shaft 220a of the pin operation lever 220 is provided at a position closer to the input portion 221 than the pin operation portion 222. Accordingly, even if the amount of movement of the input portion 221 is small, the amount of movement of the pin 250 moving in the through hole 260 is sufficiently ensured.

In the door latch device 1 according to the second embodiment, the outer lever 71 can also be operated by manually operating the key cylinder 5 provided outside the vehicle cabin using the mechanical key 7, and the latched state can be canceled. Therefore, since the mechanical key 7 is required to cancel the latched state by a manual operation from outside the vehicle cabin, the antitheft performance can be ensured. Even if the motor 41 is not driven due to power shortage or the like, the latched state can be canceled by a manual operation using the mechanical key 7 from outside the vehicle cabin, and thus the reliability of the door latch device 1 is improved.

The vehicle interior operation disabling mechanism 200 can be switched from the set state to the unset state not only by the driving of the motor 201 as described above but also by manually operating the key cylinder 5 using the mechanical key 7. The switching to the unset state using the mechanical key 7 is performed, for example, when the motor 201 is not driven due to power shortage, failure, or the like.

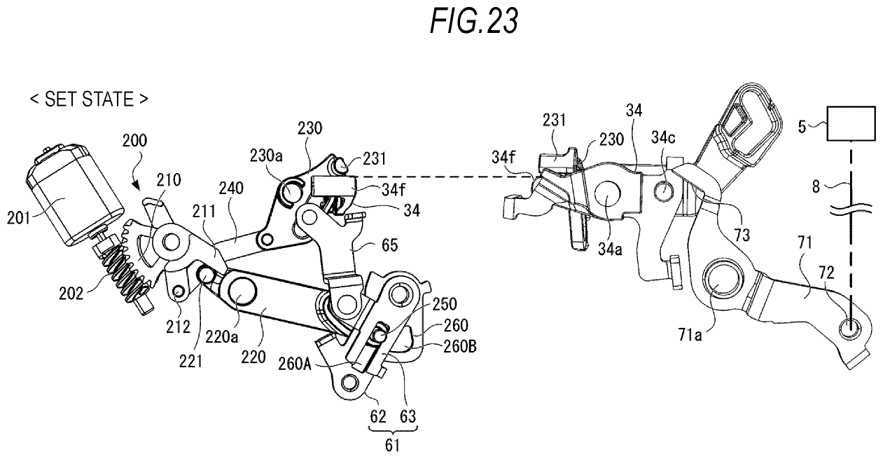

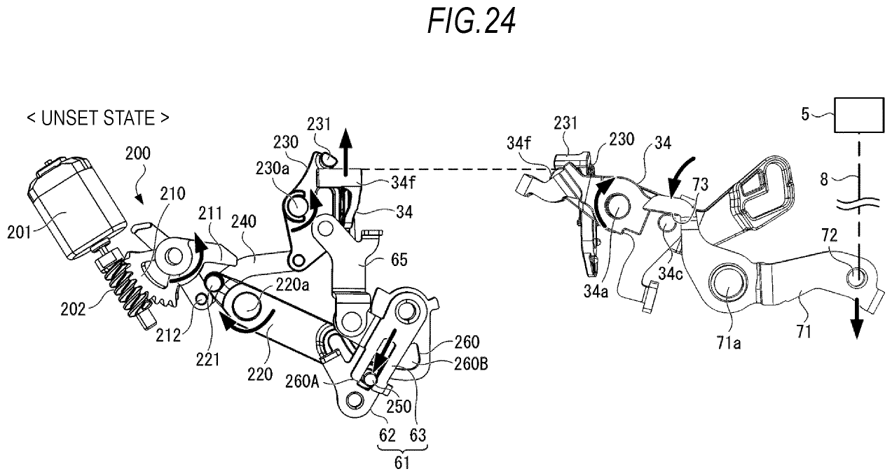

FIGS. 23 and 24 are diagrams illustrating a manner in which the door latch device 1 is shifted from the set state (FIG. 23) to the unset state (FIG. 24) by manually operating the key cylinder 5. The left ones in FIGS. 23 and 24 illustrate the vehicle interior operation disabling mechanism 200, and the right ones in FIGS. 23 and 24 illustrate the pawl lever 34 and the outer lever 71.

In a case where the door latch device 1 is in the set state, when the key cylinder 5 is operated, the input portion 72 of the outer lever 71 is pulled upward by the cable 8, and the outer lever 71 rotates around the lever shaft 71a. The operation portion 73 of the outer lever 71 is engaged with the second input portion 34c of the pawl lever 34 to press down the second input portion 34c. Accordingly, the pawl lever 34 rotates around the lever shaft 34a, the interlocking lever operation portion 34f pushes up the input portion 231 of the interlocking lever 230, and rotates the interlocking lever 230 in the counterclockwise direction around the lever shaft 230a. The latched state is canceled as the pawl lever 34 rotates.

When the interlocking lever 230 rotates in the counterclockwise direction, the sector gear 210 connected to the link member 240 rotates in the counterclockwise direction. Accordingly, the engagement between the lever engagement portion 211 of the sector gear 210 and the input portion 221 of the pin operation lever 220 is released, and the pin operation lever 220 rotates in the clockwise direction around the lever shaft 220a to move the pin 250 from the set region 260B to the unset region 260A. In this manner, the vehicle interior operation disabling mechanism 200 switches from the set state to the unset state by manually operating the key cylinder 5 using the mechanical key 7.

Even if the motor 41 becomes unable to be driven due to power shortage, failure, or the like in the set state, the vehicle interior operation disabling mechanism 200 can be switched to the unset state by manually operating the key cylinder 5 from outside the vehicle cabin, and thus the convenience can be improved. Since the latched state is canceled and the state is switched to the unset state by the manual operation of the key cylinder 5, even if the motor 41 continues to be unable to be driven, a user can cancel the latched state by manually operating the inner handle 3 after getting in a vehicle, thereby avoiding being trapped inside the vehicle.

### Third Embodiment

Next, the door latch device 1 according to a third embodiment will be described. The door latch device 1 according to the third embodiment is similar to that of the second embodiment in that the vehicle interior operation disabling mechanism 200 is provided, but the configuration of the vehicle interior operation disabling mechanism 200 is different from that of the second embodiment. Specifically, the vehicle interior operation disabling mechanism 200 according to the third embodiment does not include the motor 201, and is operated by driving the motor 41 of the electric release mechanism 40. Hereinafter, the configuration of the vehicle interior operation disabling mechanism 200 will be mainly described in detail. In the door latch device 1 according to the third embodiment, since the configurations of the latch mechanism 20 excluding the pawl lever 34 and the electric release mechanism 40 excluding the cam wheel 43 are the same as those of the door latch device 1 according to the first embodiment, descriptions and illustrations thereof may be appropriately omitted.

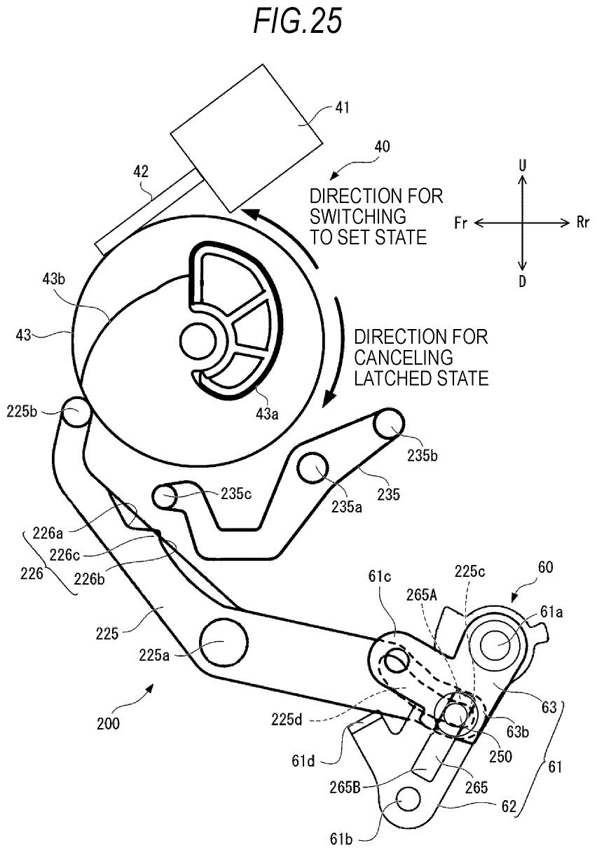

FIG. 25 is a view of the vehicle interior operation disabling mechanism 200 according to the third embodiment as viewed from the vehicle inner side. Although the electric release lever 44 (first lever 51 and second lever 52) of the electric release mechanism 40 is disposed on the vehicle inner side with respect to each element of the vehicle interior operation disabling mechanism 200, the electric release lever 44 of the electric release mechanism 40 is omitted in FIG. 25 in order to describe the configuration of the vehicle interior operation disabling mechanism 200.

Before describing the vehicle interior operation disabling mechanism 200, first, the inner lever 61 of the manual release mechanism 60 according to the third embodiment will be described.

Similarly to the inner lever 61 according to the second embodiment, the inner lever 61 according to the third embodiment includes the cancel operation lever 62 and the latch release lever 63. The cancel operation lever 62 and the latch release lever 63 are rotatable around a common lever shaft 61a. The cancel operation lever 62 includes the input portion 61b and the cancel operation portion 61d, and the latch release lever 63 includes the latch release portion 61c.

In the third embodiment, configurations of a through hole 265 formed in the cancel operation lever 62 and a coupling portion 63b of the latch release lever 63 are different from those of the through hole 260 and the coupling portion 63a according to the second embodiment.

The through hole 265 penetrates in an axial direction of the lever shaft 61a, and the pin 250 is inserted therethrough. The through hole 265 is an elongated hole extending in a radial direction of the lever shaft 61a. The through hole 265 is divided into an unset region 265A which is a portion close to the lever shaft 61a and a set region 265B which is a portion farther from the lever shaft 61a than the unset region 265A. The pin 250 inserted through the through hole 265 is movable between the unset region 265A and the set region 265B.

The coupling portion 63b of the latch release lever 63 is formed with a substantially U-shaped notch, and holds the pin 250 interposed therebetween. The coupling portion 63b overlaps the unset region 265A when viewed from the axial direction of the lever shaft 61a, but does not overlap the set region 265B. Therefore, when the pin 250 is disposed in the unset region 265A, the coupling portion 63b holds the pin 250, and when the pin 250 is disposed in the set region 265B, the coupling portion 63b does not hold the pin 250.

Similarly to the second embodiment, the latch release lever 63 can be shifted between a coupled state where the latch release lever 63 is coupled to the cancel operation lever 62 via the pin 250 and operates in conjunction with the cancel operation lever 62 and a non-coupled state where the coupling via the pin 250 is released and the latch release lever 63 does not operate in conjunction with the cancel operation lever 62. When the pin 250 is disposed in the unset region 265A, the cancel operation lever 62 and the latch release lever 63 are in the coupled state and are in an “unset state”. When the pin 250 is disposed in the set region 265B, the cancel operation lever 62 and the latch release lever 63 are in the non-coupled state and are in a “set state”

Next, the vehicle interior operation disabling mechanism 200 according to the third embodiment will be described. The vehicle interior operation disabling mechanism 200 includes a pin operation lever 225 that abuts against a second cam portion 43b provided on the cam wheel 43 and operates the pin 250, and an interlocking lever 235 that can be engaged with the pawl lever 34 and operates in conjunction with the pawl lever 34.

The second cam portion 43b provided on the cam wheel 43 is provided on a surface of the cam wheel 43 on the vehicle inner side, and one end thereof is provided continuously on an outer peripheral surface of the cam wheel 43. When the cam wheel 43 rotates in a counterclockwise direction in FIG. 25, a distance between the second cam portion 43b and a center of the cam wheel 43 decreases. The second cam portion 43b is provided at a different position in a circumferential direction from the cam portion 43a that operates the electric release lever 44.

Although details will be described later, when the cam wheel 43 is rotated reversely (in the counterclockwise direction) from a neutral position illustrated in FIG. 25, the unset state can be switched to the set state. On the other hand, when the cam wheel 43 is rotated forward (in a clockwise direction) from the neutral position illustrated in FIG. 25, the electric release lever 44 (not illustrated here) abuts against the cam portion 43a to cancel a latched state (see FIG. 11).

The pin operation lever 225 is provided between the cam wheel 43 and the inner lever 61 and extends in a front-rear direction. The pin operation lever 225 is rotatable around a lever shaft 225a. Although not illustrated, the pin operation lever 225 is normally biased in a direction (clockwise direction in FIG. 25) in which the pin operation lever 225 abuts against the cam wheel 43 by a biasing force of a coil spring provided in the housing 11.

The pin operation lever 225 includes an input portion 225b that can abut against the cam wheel 43 and receives an input of a driving force of the motor 41 via the cam wheel 43, and a pin operation portion 225c that holds the pin 250 and moves the pin 250 in conjunction with the rotation of the pin operation lever 225. The pin operation lever 220 selectively switches between the set state and the unset state by moving the pin 250. A through hole 225d through which the pin 250 is inserted and which extends in a rotation direction of the cancel operation lever 62 is formed in the pin operation portion 225c.

The pin operation lever 225 is provided with an abutment portion 226 with which the interlocking lever 235 can abut. The abutment portion 226 is provided with a first region 226a with which the interlocking lever 235 abuts in the set state, a second region 226b with which the interlocking lever 235 abuts in the unset state by the operation of the interlocking lever 235, and a protrusion 226c provided between the first region 226a and the second region 226b.

The interlocking lever 235 is disposed above the pin operation lever 225 and is rotatable around a lever shaft 235a. Although not illustrated, the interlocking lever 235 is normally biased in a direction away from the pin operation lever 225 (clockwise direction in FIG. 25) by the biasing force of the coil spring provided in the housing 11.

The interlocking lever 235 includes an input portion 235b that can be engaged with the pawl lever 34 and receives an input of an operation force from the key cylinder 5 via the outer lever 71 and the pawl lever 34, and an engagement portion 235c that is engaged with the abutment portion 226 of the pin operation lever 225. The input portion 235b is provided on the opposite side of the engagement portion 235c with the lever shaft 235a in between.

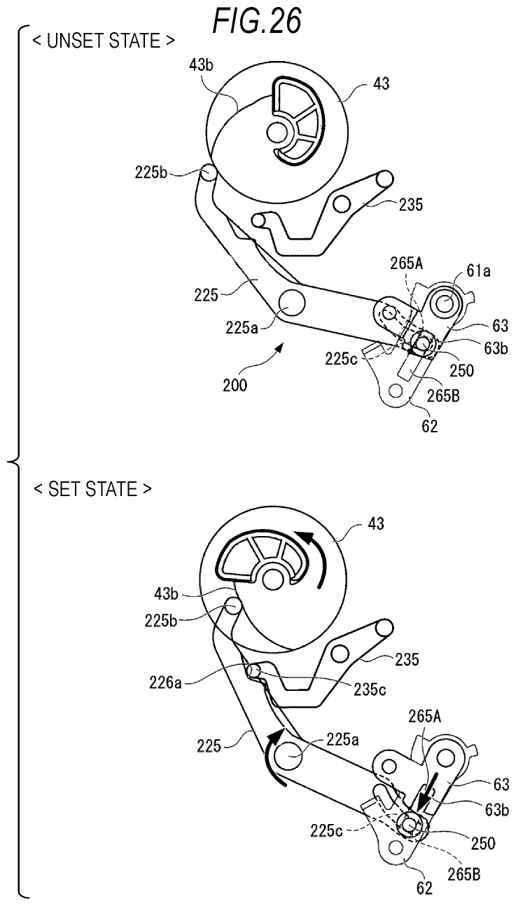

FIG. 26 is a diagram illustrating a manner in which the door latch device 1 is shifted from the unset state (upper diagram) to the set state (lower diagram) by driving of the motor 41. In a case where the motor 41 is driven such that the cam wheel 43 rotates reversely when the door latch device 1 is in the unset state, the input portion 225b of the pin operation lever 225 moves while abutting against the second cam portion 43b by a biasing force of a coil spring, and the pin operation lever 225 rotates in the clockwise direction around the lever shaft 225a as indicated by a thick arrow. Accordingly, the pin 250 moves from the unset region 265A to the set region 265B, and the unset state is switched to the set state. When the state is switched to the set state, the engagement portion 235c of the interlocking lever 235 abuts against the first region 226a of the abutment portion 226 of the pin operation lever 225.

Conversely, when switching from the set state to the unset state, the motor 41 is driven such that the cam wheel 43 rotates forward. Accordingly, the pin operation lever 225 rotates in the counterclockwise direction around the lever shaft 225a against the biasing force of the coil spring, and moves the pin 250 from the set region 265B to the unset region 265A.

As described above, since the door latch device 1 according to the third embodiment includes the vehicle interior operation disabling mechanism 200 that selectively switches between the set state and the unset state, it is possible to further improve the antitheft performance and the safety.

The vehicle interior operation disabling mechanism 200 according to the third embodiment selectively switches between the set state and the unset state by driving of the motor 41 of the electric release mechanism 40. The set state and the unset state are electrically switched, which is highly convenient. Further, since the motor 41 is shared by the electric release mechanism 40 and the vehicle interior operation disabling mechanism 200, the number of components and costs can be reduced. In addition, the door latch device 1 can be downsized.

Since the pin operation lever 225 selectively switches between the set state and the unset state by moving the pin 250, the state can be switched with good operability.

In the door latch device 1 according to the third embodiment, similarly to the first embodiment and the second embodiment, the outer lever 71 can also be operated by manually operating the key cylinder 5 provided outside the vehicle cabin using the mechanical key 7, and the latched state can be canceled. Therefore, since the mechanical key 7 is required to cancel the latched state by a manual operation from outside the vehicle cabin, the antitheft performance can be ensured. Even if the motor 41 is not driven due to power shortage or the like, the latched state can be canceled by a manual operation using the mechanical key 7 from outside the vehicle cabin, and thus the reliability of the door latch device 1 is improved.

In addition to the driving of the motor 41 as described above, the vehicle interior operation disabling mechanism 200 can also be switched from the set state to the unset state by manually operating the key cylinder 5 using the mechanical key 7. The switching to the unset state using the mechanical key 7 is performed, for example, to open the door D when the motor 41 is not driven due to power shortage, failure, or the like.

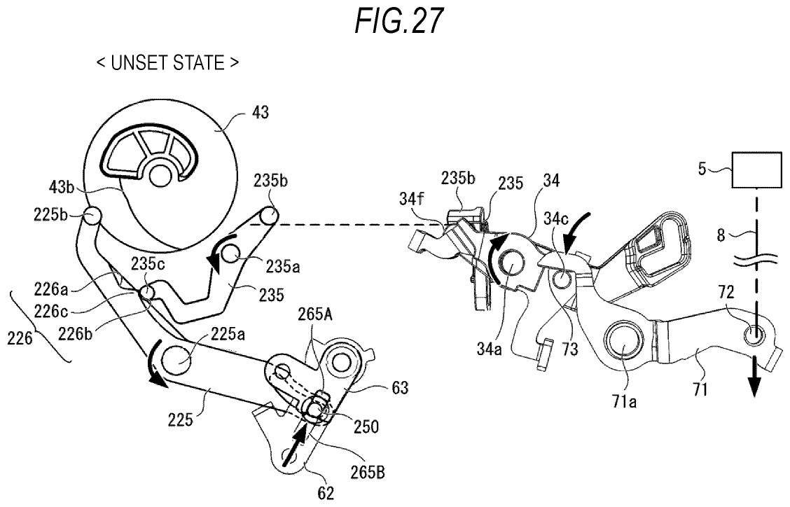

FIG. 27 is a diagram illustrating a manner in which the door latch device 1 is shifted from the set state to the unset state by manually operating the key cylinder 5. The left one in FIG. 27 illustrates the vehicle interior operation disabling mechanism 200, and the right one in FIG. 27 illustrates the pawl lever 34 and the outer lever 71.

In a case where the door latch device 1 is in the set state, when the key cylinder 5 is operated, the input portion 72 of the outer lever 71 is pulled upward by the cable 8, and the outer lever 71 rotates around the lever shaft 71a. The operation portion 73 of the outer lever 71 is engaged with the second input portion 34c of the pawl lever 34 to press down the second input portion 34c. Accordingly, the pawl lever 34 rotates around the lever shaft 34a, the interlocking lever operation portion 34f pushes up the input portion 235b of the interlocking lever 235, and rotates the interlocking lever 235 in the counterclockwise direction around the lever shaft 235a.

When the interlocking lever 235 rotates in the counterclockwise direction, the engagement portion 235c of the interlocking lever 235 slides on the abutment portion 226 of the pin operation lever 225 and moves from the first region 226a to the second region 226b over the protrusion 226c. When the engagement portion 235c passes the protrusion 226c, the interlocking lever 235 rotates the pin operation lever 225 in the counterclockwise direction around the lever shaft 225a against the biasing force of the coil spring. Accordingly, the pin 250 moves from the set region 265B to the unset region 265A, and the set state is switched to the unset state.

When an operation force of the key cylinder 5 is released after switching to the unset state, a force toward a standby position acts on the interlocking lever 235 by the biasing force of the coil spring, but the engagement portion 235c is caught and locked by the second region 226b and the protrusion 226c of the pin operation lever 225. Therefore, the unset state is maintained even after the operation force of the key cylinder 5 is released.

In this state, the input portion 225b of the pin operation lever 225 is located to partially overlap the cam wheel 43 when viewed from an axial direction of the lever shaft 225a. Therefore, when the cam wheel 43 is rotated reversely (in the clockwise direction) after the motor 41 becomes drivable, the input portion 225b abuts against an outer peripheral surface of the cam wheel 43, and the pin operation lever 225 rotates in the counterclockwise direction against the biasing force of the coil spring. Accordingly, the engagement of the engagement portion 235c is released, and the interlocking lever 235 returns to the standby position.

Although the embodiments of the present disclosure are described above with reference to the accompanying drawings, it is needless to say that the present invention is not limited to these embodiments. It is apparent to a person skilled in the art that various modifications or corrections can be conceived within the scope described in the claims, and it is understood that the modifications or corrections naturally fall within a technical scope of the present invention. Components in the above embodiments may be freely combined without departing from the gist of the disclosure.

For example, in the second embodiment and the third embodiment described above, the ECU 82 may control the motor 201 or the motor 41 that operates the vehicle interior operation disabling mechanism 200 to selectively switch between the unset state and the set state based on a speed of the vehicle V. For example, the ECU 82 may be switched to the set state when the speed of the vehicle V is equal to or higher than a predetermined speed.

The present specification describes at least the following matters. Corresponding components and the like in the embodiments described above are described in parentheses as an example, but the present invention is not limited thereto.

(1) A door latch device (door latch device 1) to be attached to a door (door D) of a vehicle (vehicle V), the door latch device including:
a latch mechanism (latch mechanism 20) including a latch (latch 24) configured to be engaged with a striker (striker S) provided on a vehicle body, and maintaining the door in a closed state with respect to the vehicle body by bringing the latch into a latched state where the latch is locked to the striker;
an electric release mechanism (electric release mechanism 40) configured to cancel the latched state by driving of a motor (motor 41); and
a manual release mechanism (manual release mechanism 60) configured to cancel the latched state by a manual operation, in which
the electric release mechanism includes an electric release lever (electric release lever 44) operated by driving the motor,
the electric release lever includes:
   a first lever (first lever 51) operated by driving the motor, and
   a second lever (second lever 52) engaged with the latch mechanism in a coupled state of operating in conjunction with the first lever, to cancel the latched state,
the manual release mechanism includes an inner lever (inner lever 61) that is operated by manually operating a vehicle interior operation portion (inner handle 3) provided inside a vehicle cabin, and
the door latch device further includes:
   a cancellation mechanism (cancellation mechanism 100) provided independently of the motor, and cancelling the coupled state between the first lever and the second lever by an operation force of the vehicle interior operation portion transmitted via the inner lever, to allow the second lever to retract from a predetermined position, and
   a vehicle interior operation disabling mechanism (vehicle interior operation disabling mechanism 200) selectively switching between a set state where an operation force of the vehicle interior operation portion is unable to be transmitted from the manual release mechanism to the latch mechanism and an unset state where the operation force of the vehicle interior operation portion is able to be transmitted from the manual release mechanism to the latch mechanism.

According to (1), since the door latch device includes the cancellation mechanism that is operated by the manual operation of the vehicle interior operation portion, even in a case where the motor becomes unable to be driven due to power shortage, failure, or the like and a latch disabled state is maintained, the latch disabled state can be canceled by manually operating the vehicle interior operation portion. Therefore, since the door can be reliably closed even in an emergency, the antitheft performance is improved, and the reliability of the door latch device is improved. Since the cancellation mechanism is provided independently of the motor, the cancellation mechanism can operate without being affected by the stuck motor, and the latch disabled state can be released with good operability.

According to (1), since the vehicle interior operation disabling mechanism is provided that selectively switches between the set state where the operation force of the vehicle interior operation portion cannot be transmitted to the latch mechanism and the unset state where the operation force can be transmitted, it is possible to further improve the antitheft performance and safety.

(2) The door latch device according to (1), in which
the manual release mechanism further includes an outer lever (outer lever 71) operated by manually operating a vehicle exterior operation portion (key cylinder 5) provided outside the vehicle cabin using a tool (mechanical key 7), and
the outer lever moves by manually operating the vehicle exterior operation portion and is engaged with the latch mechanism to cancel the latched state.

According to (2), since the tool (for example, a mechanical key) is required to cancel the latched state by a manual operation from outside the vehicle cabin, the antitheft performance can be ensured. Even if the electric release mechanism does not operate due to power shortage or the like, the latched state can be canceled by a manual operation using a tool from outside the vehicle cabin, and thus the reliability of the door latch device is improved.

(3) The door latch device according to (1), in which
the vehicle interior operation disabling mechanism selectively switches between the set state and the unset state by driving the motor of the electric release mechanism or another motor (motor 201) different from the motor.

According to (3), the set state and the unset state are electrically switched, which is highly convenient.

(4) The door latch device according to (3), in which
the vehicle interior operation disabling mechanism selectively switches between the set state and the unset state by driving the motor of the electric release mechanism.

According to (4), since the motor is shared by the electric release mechanism and the vehicle interior operation disabling mechanism, the number of components and costs can be reduced.

(5) The door latch device according to (2), in which
the vehicle interior operation disabling mechanism selectively switches between the set state and the unset state by driving the motor of the electric release mechanism or another motor (motor 201) different from the motor, and
the vehicle interior operation disabling mechanism switches from the set state to the unset state by manually operating the vehicle exterior operation portion using the tool.

According to (5), if the motor fails in the set state, the vehicle interior operation disabling mechanism can be switched to the unset state by manually operating using a tool from outside the vehicle cabin, and thus the convenience can be improved. Since the latched state is released and the state is switched to the unset state by the manual operation of the vehicle exterior operation portion, a user can release the latched state by manually operating the vehicle interior operation portion after getting in a vehicle, thereby avoiding being trapped inside the vehicle.

(6) The door latch device according to any one of (1) to (5), in which
the inner lever of the manual release mechanism includes:
   a cancel operation lever (cancel operation lever 62) operated by manually operating the vehicle interior operation portion, and transmitting an operation force of the vehicle interior operation portion to the cancellation mechanism; and
   a latch release lever (latch release lever 63) transmitting an operation force of the vehicle interior operation portion to the latch mechanism in a coupled state of operating in conjunction with the cancel operation lever, to cancel the latched state, and
in a case where the inner lever is in the set state, the inner lever enters a non-coupled state where the coupling between the cancel operation lever and the latch release lever is released, and an operation force of the vehicle interior operation portion is transmitted to the cancellation mechanism by the cancel operation lever.

According to (6), even in the set state, the operation force of the vehicle interior operation portion is transmitted to the cancellation mechanism by the cancel operation lever, and thus the latch disabled state can be released by the manual operation of the vehicle interior operation portion even if the motor is not driven due to power shortage, failure, or the like. Therefore, the safety and the antitheft performance can be ensured.

(7) The door latch device according to (6), in which
the latch release lever is configured to be shifted between the coupled state where the latch release lever is coupled to the cancel operation lever via a pin (pin 250) and operates in conjunction with the cancel operation lever and the non-coupled state where the coupling via the pin is released and the latch release lever does not operate in conjunction with the cancel operation lever, and
the vehicle interior operation disabling mechanism includes a pin operation lever (pin operation levers 220 and 225) selectively switching between the set state and the unset state by moving the pin.

According to (7), since the set state and the unset state are selectively switched by moving the pin, the state can be switched with good operability.

What is claimed is:

1. A door latch device to be attached to a door of a vehicle, the door latch device comprising:
a latch mechanism including a latch configured to be engaged with a striker provided on a vehicle body, and maintaining the door in a closed state with respect to the vehicle body by bringing the latch into a latched state where the latch is locked to the striker;
an electric release mechanism configured to cancel the latched state by driving a motor; and
a manual release mechanism configured to cancel the latched state by a manual operation, wherein
the electric release mechanism includes an electric release lever operated by driving the motor,
the electric release lever includes:
a first lever operated by driving the motor; and
a second lever engaged with the latch mechanism in a coupled state of operating in conjunction with the first lever, to cancel the latched state,
the manual release mechanism includes an inner lever operated by manually operating a vehicle interior operation portion provided inside a vehicle cabin, and
the door latch device further comprises:
a cancellation mechanism provided independently of the motor, and canceling the coupled state between the first lever and the second lever by an operation force of the vehicle interior operation portion transmitted via the inner lever, to allow the second lever to retract from a predetermined position; and
a vehicle interior operation disabling mechanism selectively switching between a set state where an operation force of the vehicle interior operation portion is unable to be transmitted from the manual release mechanism to the latch mechanism, and an unset state where the operation force of the vehicle interior operation portion is able to be transmitted from the manual release mechanism to the latch mechanism.

2. The door latch device according to claim 1, wherein
the manual release mechanism further includes an outer lever operated by manually operating a vehicle exterior operation portion provided outside the vehicle cabin using a tool, and
the outer lever moves by manually operating the vehicle exterior operation portion, and is engaged with the latch mechanism to cancel the latched state.

3. The door latch device according to claim 1, wherein
the vehicle interior operation disabling mechanism selectively switches between the set state and the unset state by driving the motor of the electric release mechanism or another motor different from the motor.

4. The door latch device according to claim 3, wherein
the vehicle interior operation disabling mechanism selectively switches between the set state and the unset state by driving the motor of the electric release mechanism.

5. The door latch device according to claim 2, wherein
the vehicle interior operation disabling mechanism selectively switches between the set state and the unset state by driving the motor of the electric release mechanism or another motor different from the motor, and
the vehicle interior operation disabling mechanism switches from the set state to the unset state by manually operating the vehicle exterior operation portion using the tool.

6. The door latch device according to claim 1, wherein
the inner lever of the manual release mechanism includes:
a cancel operation lever operated by manually operating the vehicle interior operation portion, and transmitting an operation force of the vehicle interior operation portion to the cancellation mechanism; and
a latch release lever transmitting an operation force of the vehicle interior operation portion to the latch mechanism in a coupled state of operating in conjunction with the cancel operation lever, to cancel the latched state, and
in a case where the inner lever is in the set state, the inner lever enters a non-coupled state where the coupling between the cancel operation lever and the latch release lever is released, and an operation force of the vehicle interior operation portion is transmitted to the cancellation mechanism by the cancel operation lever.

7. The door latch device according to claim 6, wherein
the latch release lever is configured to be shifted between the coupled state where the latch release lever is coupled to the cancel operation lever via a pin and operates in conjunction with the cancel operation lever, and the non-coupled state where the coupling via the pin is released and the latch release lever does not operate in conjunction with the cancel operation lever, and
the vehicle interior operation disabling mechanism includes a pin operation lever selectively switching between the set state and the unset state by moving the pin.
